(19) United States
(12) Patent Application Publication
(10) Pub. No.: US 2007/0297366 A1
(43) Pub. Date: Dec. 27, 2007

(54) Synchronized wireless mesh network

(76) Inventor: Robert Osann, Cupertino, CA (US)

Correspondence Address: FLIESLER MEYER LLP, 650 CALIFORNIA STREET, 14TH FLOOR, SAN FRANCISCO, CA, 94108, US

(21) Appl. No.: 11/516,995

(22) Filed: Sep. 7, 2006

Related U.S. Application Data
(60) Provisional application No. 60/756,794, filed on Jan. 5, 2006.

(51) Int. Cl. H04Q 7/00

(52) U.S. Cl. 370/331

(57) ABSTRACT

A synchronized wireless mesh network is described where mesh nodes have one or more relay radios and multiple directional antennas aimed in horizontally orthogonal directions. A rectangular grid of such mesh nodes can include at least 4 nodes arranged in a rectangular formation such that diagonally aligned nodes are incapable of communicating directly to each other. Adjacent nodes, on the other hand, can be controlled to transmit and receive to each other in an alternating sequence. Thus, diagonally aligned nodes can be controlled to transmit and receive in unison. Such a network can enable for greater speed and simultaneity of packet propagation and provide for less interference amongst adjacent nodes. Other embodiments are also described where radio transmission and reception at a particular node having multiple radios are synchronized to eliminate co-channel, adjacent channel and cross-channel interference.

### CLAIM OF PRIORITY

This application claims the benefit and priority of U.S. Provisional Application Ser. No. 60/756,794, filed on Jan. 5, 2006, and entitled “DIRECTIONAL AND INTERLEAVED WIRELESS MESH NETWORKS,” commonly assigned with the present application and incorporated herein by reference.

### CROSS REFERENCES TO RELATED APPLICATIONS

This application is related to and cross references the following U.S. patent applications, which are incorporated herein by reference:

U.S. patent application Ser. No. XX/XXX,XXX entitled “INTERLEAVED WIRELESS MESH NETWORK,” by Robert Osann, Jr., filed on XXXX, 2006, Attorney Docket No. OSAN-01004US0.

U.S. patent application Ser. No. XX/XXX,XXX entitled “INTERLEAVED AND DIRECTIONAL WIRELESS MESH NETWORK,” by Robert Osann, Jr., filed on XXXX, 2006, Attorney Docket No. OSAN-01003US0.

U.S. patent application Ser. No. XX/XXX,XXX entitled “COMBINED DIRECTIONAL AND MOBILE INTERLEAVED WIRELESS MESH NETWORK,” by Robert Osann, Jr., filed on XXXX, 2006, Attorney Docket No. OSAN-01006US0.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates generally to the field of wireless mesh networks for public safety and general public access applications.

### BACKGROUND OF THE INVENTION

Typical wireless mesh networks use a single radio for the backhaul or relay function where packets are moved through the mesh from node to node. This causes a significant bandwidth limitation since a single radio cannot send and receive at the same time. Adding relay radios at individual mesh nodes can enable a mesh node to simultaneously send and receive packets, thereby increasing the overall rate of bandwidth propagation through the mesh node. The simplest form of prior art mesh network is the ad hoc mesh network shown in FIG. 1(a), where each mesh node 101 contains a relay radio 102. This is the most elemental form of wireless mesh network and originated in the military. It was characteristic of these networks that all mesh nodes have a single radio and all radios operate on the same channel or frequency.

Note that in this specification, the term “channel” is most often used to mean a specific RF frequency or band of frequencies. However, the term “channel” is to be understood in a generalized sense as designating a method of isolating one data transmission from others such that they do not interfere. While this differentiation or isolation may be accomplished by utilizing different frequencies, it may also be accomplished by choosing different RF wave polarizations or in the case of a TDMA scheme, it may refer to different time slots in a time division scheme. For CDMA systems, isolation of transmissions may result from having different spreading codes. Regardless, channelization is a method for making efficient use of available spectrum and preventing interference between different transmissions that otherwise might interfere with each other.

One evolution of the early ad hoc mesh network form is shown in FIG. 1(b) where relay radio 103 is capable not only of transferring packets to adjacent nodes, but is also capable of operating as an access point (AP) as well, providing service (typically WiFi) to client devices such as laptop computers, wireless PDAs, and WiFi VoIP phones.

The architecture of FIG. 1(b) suffers from performance limitations since the single radio must not only relay packets, but also service numerous client radios 104 at each node. Thus, another evolution was developed as shown in FIG. 1(c), where each mesh node has a separate service or AP radio 105 in addition to relay radio 106. This allows client devices 107 to communicate with service radio 105 on a different channel or frequency than relay radio 106, thereby reducing interference effects within the mesh and increasing performance.

A more recent evolution of mesh architectures is shown in FIG. 1(d) where relay radios 108 and 109 are used at each mesh node along with a separate service radio 110. Here, packets can be received on relay radio 108 while simultaneously being transmitted on relay radio 109, and vice versa, thereby increasing performance due to both the simultaneous operation of both radios, as well as the fact that radios 108 and 109 typically operate on different channels, thereby further reducing interference effects in the mesh. It is also known to add radios to the architecture shown in FIG. 1(d) such that there would be two relay radios for uplink replacing relay radio 108, and two relay radios for downlink replacing relay radio 109. This addition effectively doubles the bandwidth and enables full-duplex (simultaneous uplink and downlink) operation, however a specific packet stream will propagate through only one of a pair of uplink or downlink radios. Thus, the maximum performance of such a link between two nodes will only be realized in situations where traffic loading is high. The absolute performance of a single stream of packets will not be increased beyond what a single link could deliver.

While FIG. 1 shows the architectures for various prior art mesh networks in a one-dimensional form for sake of simplicity, FIG. 2 elaborates on the architecture of FIG. 1(d) showing a two-dimensional view. In the 3-radio mesh of FIG. 2, also known as a “structured” mesh, a tree-like structure is formed emanating from a root node 201 which connects directly to a wired network 202. This wired network can, in turn, connect to the Internet or alternatively, it may connect simply to a server. In the case of a public safety network, the wired network will often connect to the Command and Control center. It is characteristic of this type of mesh that, at every hop, packets being relayed travel on a different channel from the previous hop. Thus RF transmissions, 202, 203, and 204 which connect mesh node 201a with mesh nodes 205, 206, and 207, operate on three different channels or frequencies as shown by the different styles of dotted line. In this type of mesh network, the mesh control software on each node has a significant challenge in assigning the various available channels throughout the mesh such that interference effects are minimized, and the mesh functions properly. Some mesh network vendors rely on customers to manually assign channels as the units are being installed. Other mesh vendors have developed very elaborate dynamic channel assignment software programs, which perform this function automatically. Either way, having a mesh network where channels change from hop to hop is complicated and difficult to deal with. In the case of a public safety mesh with mobile nodes (for vehicles and individual First Responders on foot), a further problem arises with this form of mesh. For instance, if a group of first responders each carrying a mesh node become isolated from the backhaul connection to the server (Command and Control), the tree-like structure of FIG. 2 may become compromised since there is no longer a defined root for the tree. It is important for isolated groups of first responders, with nodes that are vehicle mounted, man-carried, or both, to continue communicating amongst themselves when isolated until the connection to Command and Control is restored.

FIG. 3 shows example channel configurations in a WLAN Mesh from section 4.2.3 of IEEE 802.11-06/0328r0, the Combined Proposal for the ESS Mesh Standard (published in March 2006). It should be noted that the publication referenced here post dates the filing of U.S. Provisional Application Ser. No. 60/756,794 to which the present application claims priority. However, in the event that this information had been published in previous submittals at prior IEEE standards meetings, and also for purposes of clarity, the information in this publication is being described herein. FIG. 3(a) shows a simple ad hoc mesh, while FIG. 3(b) shows two ad hoc meshes, 301 and 302, which are bridged by central mesh node 303 having two radios. FIG. 3(c) shows a number of mesh nodes, each having two radios for packet relay, which for the most part are being utilized in a manner similar to the “structured” mesh of FIG. 2. FIG. 3(c) also demonstrates the concept of nodes with 2-radio relays being used to bridge between one sub-mesh and another. This referenced proposal for a new mesh standard also discusses the concept of Unified Channel Graphs or UCGs. In FIGS. 3(d) and 3(e), notice that FIGS. 3(b) and 3(c) are replicated with superimposed circles 304 indicating nodes which communicate with each other on a particular channel. Essentially FIG. 3(e) demonstrates a number of sub-meshes which are bridged by mesh nodes, each bridging node containing two relay radios. One can easily imagine the challenge in assigning channels to the network demonstrated in FIGS. 3(c) and 3(e). Also, when connections between nodes must change because of a node failure, temporary disturbances to the mesh (moving obstacles or radar interference), node movement, or QOS considerations, there can be a ripple effect of changing channels causing even greater complexity.

FIG. 4 shows the architecture for the only mesh network solution that currently supports both public safety and public access, and is being sold by Motorola. Here, there are two completely separate mesh systems embodied in the same enclosure 401. Each enclosure has two radios 402 for public safety and two radios 403 for public access. Each of these separate meshes functions as a “1+1” mesh as demonstrated in FIG. 1(c) by radio elements 105 and 106. This vendor has chosen to make the public access radios utilize 2.4 GHz for both relay and service, with 4.9 GHz being utilized for the public service radios (relay and service). Each of these meshes is separate from the other with no interaction. In particular, packet traffic on the 4.9 GHz mesh may only be used for public service as governed by law—public access traffic may never utilized 4.9 GHz. Thus, this prior art solution addresses the problem that it is desirable to reduce the number of mesh unit enclosures that must be mounted at strategic locations to cover a metropolitan area. However, the solution does not integrate any additional functionality beyond what is shown in FIG. 4, and from a performance standpoint, each of the two individual mesh networks embodied here will have the performance restrictions of other prior art mesh architectures constructed according to FIG. 1(c).

It would therefore be desirable to have a wireless mesh network architecture with the performance characteristics provided by a 2-radio relay, without the complexity of managing multiple and dynamically changeable channels, which can change from hop-to-hop.

The majority of mesh nodes being installed today use omnidirectional antennas for the relay or backhaul function to transfer packets between mesh nodes. While some mesh vendors claim to have installed mesh networks in hundreds of cities, all but a few of these are suburban towns, not large cities with tall buildings. In fact, none of the mesh systems offered today have been designed to handle the problems encountered in the depths of larger cities where high rise buildings create a “concrete canyon” effect. When today's mesh nodes are deployed in such situations, much of the energy radiated from their omni-directional antennas is reflected and/or wasted. As will be shown in FIGS. 11 and 12, in such circumstances most of the energy radiated from a relay radio's omnidirectional antenna is directed at buildings, rather than down the street corridor to where other mesh nodes are located. Here, directional or sector antennas can offer significant advantages. Throughout this specification, directional and sector antennas are often used interchangeably. This is because they sometimes are interchangeable when one desires to focus the transmitted RF radiation, depending on just how narrow a beam is desired. In one sense, any antenna that is not “omnidirectional” can be considered “directional”. However, among RF engineers, there is often a distinction between sector and directional antennas, as they differ to some extent. A sectoral or sector antenna has a horizontal beam angle that is measured in substantial portions of 180 degrees, most frequently, 90 degrees. They are often available with horizontal beam angles as small as 30 degrees, and one can think of them as covering a piece of the “360 degree pie”, hence the term “sector”. To focus the RF energy even more, a variety of types of “directional” antennas are available, usually with significantly higher gains. Directional antennas come in a variety of configurations referred to as “dish”, “panel”, “patch”, or “reflector grid”, to name a few. A 32 dBi dish antenna, for instance, would have both horizontal and vertical beam widths of 5 degrees, not something one would think of as covering a “piece of a pie” as with sector antennas.

Other factors involved in mesh node and mesh architecture design involve both the transmit power and cost of radio cards. The cost of radio cards for wireless networks is becoming increasingly lower, and although many of these have relatively low power, when combined with directional or sector antennas the EIRP (total transmitted power output from the antenna) can be more than acceptable, especially if utilized in a city deployment where the transmit energy can be focused in order to propagate between buildings, rather than wasted by transmitting into buildings.

### SUMMARY

An interleaved mesh is described that uses at least two relay radios on each node to create two or more simultaneous mesh networks, each on separate channels. A transmitted stream of packets will then utilize any or all of these multiple simultaneous meshes as they propagate through the overall mesh network. For any particular hop, a packet may use any of the available meshes to propagate to the next node. From hop to hop, a particular packet may change which mesh it travels on to reach the next node. Here, two sequential packets in a particular packet stream may travel on the same mesh or on different meshes for any given hop. Two sequential packets can even be transmitted simultaneously from a first node to a second node. Thus, a single stream of sequential packets may be transmitted between two mesh nodes at twice the speed that would normally occur if only a single link were used, or even if multiple links were used but limited to propagating unique streams of packets separately on each link. Therefore, the performance of the highest priority packet stream will be improved regardless of whether traffic loading in the mesh is high or low at the time of transmission.

When two radios are used on a particular node for packet relay according to an interleaved mesh per this invention, data can be received on one radio while simultaneously being sent on the other radio. This circumvents the limitations of a single radio system without requiring complex channel management schemes, while at the same time providing a mesh that can easily operate without a server or internet connection—critically important for Public Safety applications when isolated First Responders are separated from their backhaul connection and must communicate among themselves.

To take advantage of the low cost of commonly available radio cards while compensating for their relatively low power and receive sensitivity, a mesh architecture is also described where a relatively large number of radios is used with multiple directional or sector antennas, or multi-element directional antennas, such that radiated energy is effectively focused. This is particularly useful in urban applications where the relay or backhaul path between nodes must travel between tall buildings, a narrow beam directional or sector antenna being most efficient for the task. This directional mesh architecture is designed as shown such that it is compatible with the interleaved mesh described earlier, thus facilitating a Public Safety mesh that supports both fixed nodes (with directional or sector antennas) and mobile nodes (with omni antennas) where the mobile nodes can be man-carried or mounted on vehicles.

Frequencies utilized include licensed bands for Public Safety applications and un-licensed bands for Public Service (Public Access) applications. Architectures are also shown that support both Public Safety applications and Public Service applications simultaneously.

In summary, one object of this invention is to increase performance when packets are relayed through the mesh by providing multiple radios on each node for the relay function. Here, two sequential packets in a particular packet stream may travel on the same mesh or on different meshes for any given hop.

Another object of this invention is to provide multiple radios on each mesh node without requiring a dynamic channel assignment scheme, and thereby utilizing simpler and more mature mesh management software.

Another object of this invention is to provide a more robust mesh architecture where redundant meshes are used between nodes, thereby maintaining an automatic backup path should any disturbance happen to one of the multiple mesh packet propagation paths.

Another object of this invention is to provide an alternative path for packets on a different channel should radar interference occur on one channel causing one of the multiple interleaved meshes to need to change channels, otherwise known as DFS or Dynamic Frequency Selection. Here, when radar interference occurs on a channel of a first mesh of the multiple meshes of an interleaved mesh network, traffic can continue to propagate on a second mesh while the first mesh changes to a different channel. This eliminates the gap in performance that occurs when a DFS change is executed on prior art meshes. Thus all nodes in the system are aware of the number of meshes available and the channels they each utilize.

Another object of this invention is to support mobile public safety mesh, while providing an increased level of performance over traditional mobile mesh with single radio relay.

Another object of this invention is to provide an architecture where multiple radios can be utilized at lower frequencies with higher penetration capabilities for certain public safety applications. Frequencies in the 700 MHz to 900 MHz range have great penetration and range capabilities, but are prone to adjacent channel interference. By using two interleaved meshes on greatly separated frequencies, these problems can be overcome and provide a 2-radio relay capability. Interference problems between multiple radios on the same node can also be overcome per this invention by synchronizing them such that they can either send or receive at the same time, while never allowing one to receive while the other is sending.

Another object to this invention is to support directional or sector antennas on fixed mesh nodes in an architecture which integrates seamlessly with mobile mesh nodes, and supports a multi radio relay on both fixed and mobile mesh nodes.

Another object of this invention is to support mobile mesh nodes with multiple radio relay capability that are able to operate independently as an isolated group, when such groups are isolated from a primary server or command and control connection.

Another object of this invention is to support fixed mesh nodes with multiple directional or sector antennas, where some radios on the same node connect to antennas facing in different directions and operating on the same channel, thus enabling communication with mobile nodes which simultaneously support multiple meshes on multiple radios. Also, utilizing radios and antennas operating on the same channel but facing in different directions on the same mesh node reduces the total number of channels required for the mesh. Reducing the total number of channels required for the mesh can also provide more available spectrum for technologies such as channel bonding which can further increase performance.

Another object of this invention is to support fixed mesh nodes with multiple directional or sector antennas, where some radios on the same node connect to antennas facing in different directions and operating on the same channel, and these radios operate independently but are controlled such that the actions of transmitting and receiving are coordinated to eliminate the possibility that one radio is attempting to receive while another radio on the same mesh node and same channel is transmitting, thereby eliminating the local co-channel interference which would otherwise result at that node.

Another object of this invention is to provide a mesh infrastructure with multiple radios that provides higher performance overall for video broadcast distribution and video multicast for video surveillance.

Another object of this invention is to provide multiple radios connected to multiple sector antenna structures, where individual sector antennas are “ganged” together as constructed to form a single antenna assembly.

Another object of this invention is to provide multiple groups of sector antennas where each group is “ganged” together, each gang of sector antennas being individually adjustable in both azimuth and elevation.

Another object of this invention is to provide an interleaved mesh architecture where WiMax radios could be utilized for the relay function as well as the service radio function for client access.

Another object of this invention is to provide an interleaved mesh architecture where MIMO radios and antennas could be utilized.

### BRIEF DESCRIPTION OF THE DRAWINGS

The present invention is described with respect to particular exemplary embodiments thereof and reference is accordingly made to the drawings in which:

FIG. 1 shows a 1-dimensional view for a variety of prior art mesh network architectures, including both 1-radio relay and 2-radio relay.

FIG. 2 shows a prior art “structured” mesh architecture with 2-radio relay in a 2-dimensional view.

FIG. 3 shows example topologies and channel configurations in a WLAN Mesh from section 4.2.3 of IEEE 802.11-06/0328r0, the recently published Combined Proposal for the ESS Mesh Standard (March 2006).

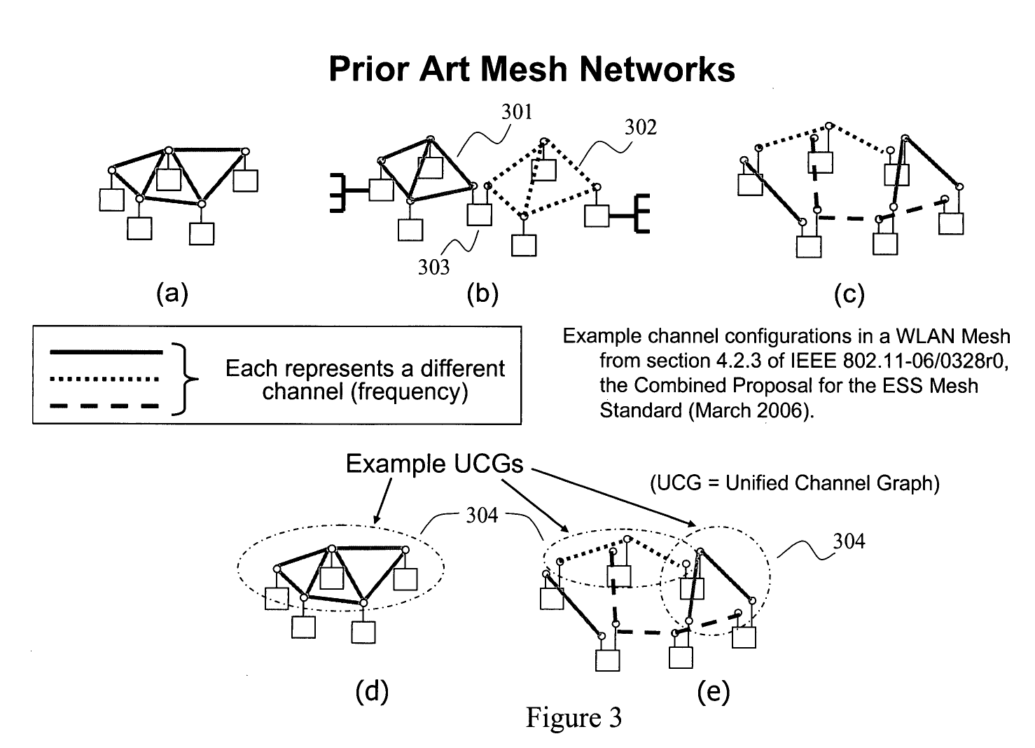

FIG. 4 shows a prior art mesh network which supports both public safety and public access by combining two separate mesh networks in one enclosure, each mesh network supported with one relay radio and a separate AP radio.

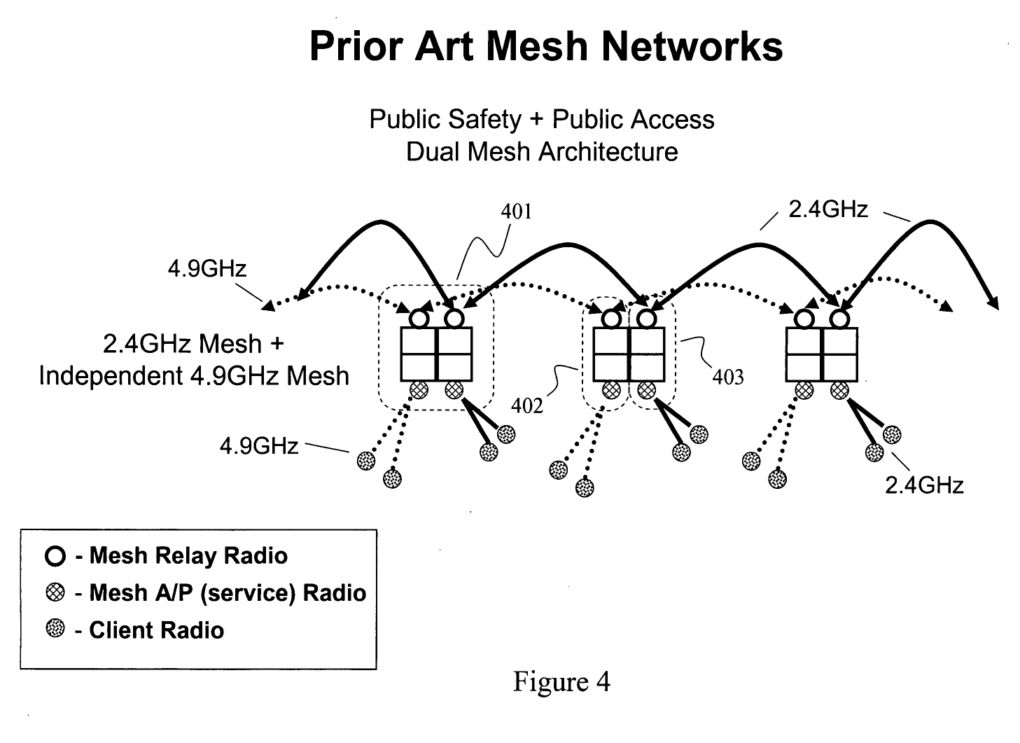

FIG. 5 shows one example of an interleaved wireless mesh network per the present invention, where each mesh node has at least two radios supporting at least two parallel mesh networks that are used in conjunction to propagate a single packet stream.

FIG. 6 shows the interleaved mesh network of the present invention, demonstrating how a single packet stream propagates by using both meshes, traveling on one or the other mesh for any given hop.

FIG. 7 shows the interleaved mesh network of FIG. 6 where a service or AP radio has been added, so that the mesh can communicate with client devices such as laptop computers independent of communications which happen on the relay radios.

FIG. 8 shows some examples of how packets can propagate through an interleaved mesh, ignoring interference affects.

FIG. 9 shows how bandwidth degrades over a one radio relay as a result of adjacent node interference effects.

FIG. 10 shows some examples of how packets can propagate through an interleaved mesh once interference affects are taken into account.

FIG. 11 shows a problem that results when omnidirectional antennas are used in a city with tall buildings.

FIG. 12 shows a solution to the problem of FIG. 11 where multiple sector antennas are used to focus energy between tall buildings in a city.

FIG. 13 shows a problem that results when omnidirectional antennas are used over irregular terrain.

FIG. 14 shows a solution to the problem of FIG. 13 where sector antennas may be aimed in order to compensate for irregular terrain.

FIG. 15 shows an interleaved directional mesh where multiple sector antennas are used in different directions, and also shows the energy radiation pattern for a 90° sector antenna.

FIG. 16 shows an interleaved directional mesh where multiple sector antennas are used in different directions, and a single radio with a four-way (4:1) splitter is used to simultaneously drive four antennas which face in four substantially orthogonal directions.

FIG. 17 shows an interleaved directional mesh where multiple sector antennas are used in different directions, and a single radio with a four-way (4:1) splitter is used to simultaneously drive four antennas which face in four substantially orthogonal directions, an independent RF switch being placed between each output of the four-way splitter and each of the four orthogonally directed sector antennas.

FIG. 18 shows an interleaved directional mesh organized in a grid with nodes placed at intersections in a city, the mesh nodes in the grid being controlled such that alternate mesh nodes transmit or receive in unison in order to control co-channel interference effects on each node.

FIG. 19 shows packet propagation through a one-dimensional representation of the mesh of FIG. 18. Two packets are shown propagating in opposite directions through the mesh in a time sequence.

FIG. 20 shows a number of scenarios for a directional mesh node with four independent radios connected to four orthogonally arranged antennas, the radios being individually controlled such that transmit and receive amongst the four radios is coordinated to minimize co-channel interference at the node.

FIG. 21 shows a multi-function mesh node that supports both Public Safety and Public Access functions with a separate interleaved mesh for each. This fixed mesh node implements the directional mesh paradigm described herein with a “ganged antenna” approach, and also communicates with mobile nodes having omnidirectional antennas that also utilize the interleaved mesh paradigm. Also incorporated with the mesh node of FIG. 21, either integral with or attached thereto are various sensors for video surveillance and airborne hazardous materials as well as seismic and wind sensors, thereby enabling a grid of such mesh nodes to effectively form a comprehensive sensor network covering a metropolitan area.

FIG. 22 shows a detailed picture of the ganged sectoral antenna array that can be used in the implementation of the directional mesh node of FIG. 21.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

One of the key components of the present invention is the new functionality herein called interleaved wireless mesh. In an interleaved mesh, at least two physical wireless mesh networks are utilized in parallel to propagate single streams of packets. In other words, a packet being transmitted from a mesh node will always have a choice of two or more meshes on which to propagate to the next mesh node, thus increasing the number of radios which can be simultaneously utilized to propagate a single packet stream. Note that a “packet stream” refers to a specific sequential stream of IP packets. Here, two sequential packets in a particular packet stream may travel on the same mesh or on different meshes for any given hop. Two sequential packets can even be transmitted simultaneously from a first node to a second node. Thus, a single stream of sequential packets may be transmitted between two mesh nodes at twice the speed that would normally occur if only a single link were used, or even if multiple links were used but limited to propagating unique streams of packets separately on each link. Therefore, the performance of the highest priority packet stream will be improved regardless of whether traffic loading in the mesh is high or low at the time of transmission.

Unlike prior art mesh networks with multi-radio relay architectures, the interleaved mesh does not require a complicated channel assignment scheme since typically each of the two meshes connecting to a given mesh node will always be on the same channels from hop to hop. Essentially, an interleaved mesh will utilize multiple, parallel physical meshes to act like a single logical mesh network.

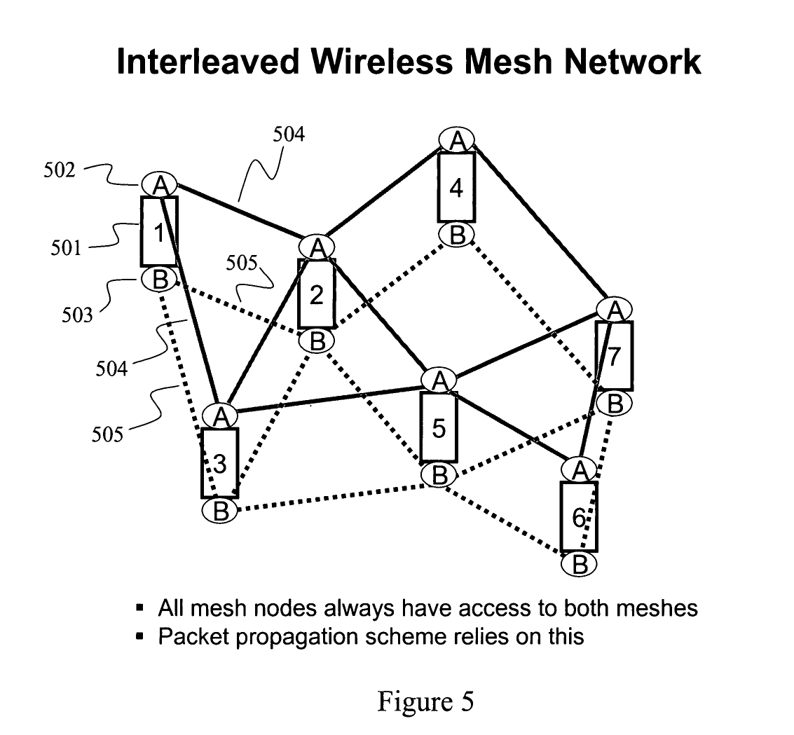

The basic architecture for interleaved mesh is most easily shown for an implementation where omnidirectional antennas are used and each mesh node has only two relay radios. This is demonstrated in FIG. 5 where mesh node 501 has two radios, radio 502 operating on a mesh which uses channel A and radio 503 operating on a mesh which uses channel B. Thus, radio 502 will make RF connections 504 on channel A to nodes 2 and 3, and radio 503 will make RF connections 505 on channel B to nodes 2 and 3. In this architecture all mesh nodes always have access to both mesh networks. As will be shown, the packet propagation scheme for an interleaved mesh relies on this fact, and both meshes are utilized to propagate a single packet stream. Since each relay radio in FIG. 5 is typically capable of connecting to all adjacent interleaved mesh nodes as shown, the concept of adjacency is important. For example, in FIG. 5, nodes 1,3,4, and 5 would all be considered as adjacent to node 2. Adjacent nodes are those with both physical position and connected RF signal strength so as to make a proper RF connection between them.

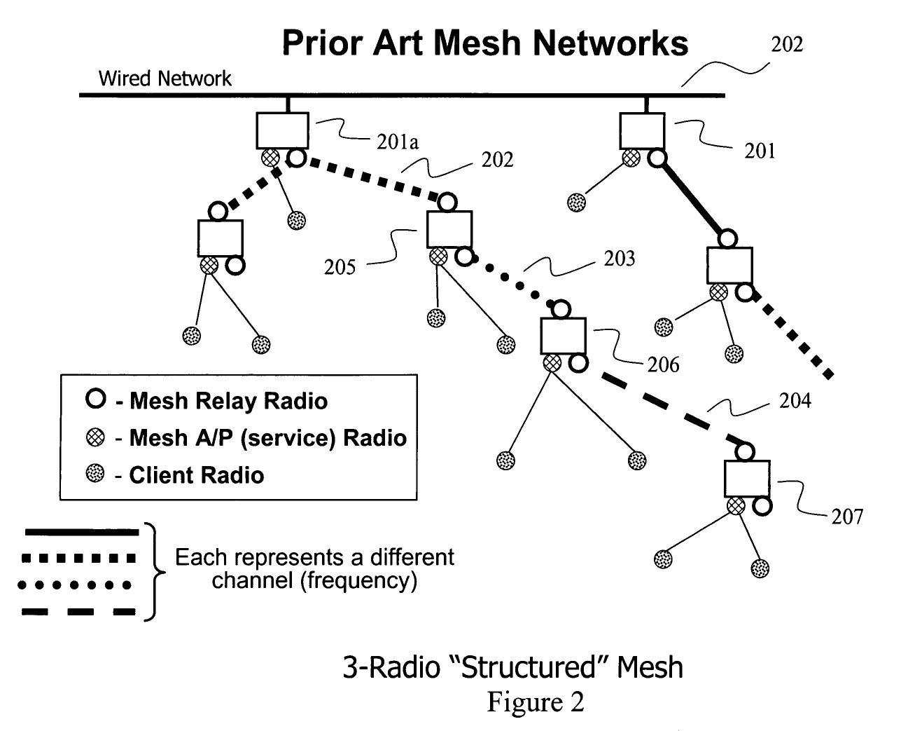

One benefit of having multiple, parallel meshes to propagate packets occurs when DFS (Dynamic Frequency Selection) is required to compensate for radar interference in certain frequency bands. Such a capability is required in a number of countries especially for the 5 GHz band. The European ETSI spec includes a required DFS capability. DFS provides an alternative path for packets on a second channel should radar interference occur on a first channel. The DFS specification as embodied in ETSI EN 301 893 v1.3.1 (August 2005) for the most part assumes a point to multipoint architecture where a single master device (at the hub) acts to control the slave devices relative to frequency channel utilization. However, the specification also states that devices capable of communicating in an ad-hoc manner shall also deploy DFS and should be tested against the requirements applicable to a master device according to the specification. For a conventional prior art mesh network, this means that if one mesh node detects interference on a particular frequency channel, it must notify all other mesh nodes that utilize that channel to change all communications currently operating on that channel to a different channel. For mesh networks with a single radio, single channel relay, this means that there will be an interruption in service during the “channel move time” which according to this specification can be as long as 10 seconds. An interruption of the just a few seconds can destroy a VoIP conversation and cause data losses where data streams back up and overflow data buffers. Even architectures such as that shown in FIG. 2 which include dynamic channel assignment, will have some data interruption while a number of links throughout the mesh are changed to alternate channels.

The interleaved mesh according to this invention handles DFS scenarios while maintaining a level of performance at least 50% as great as the maximum capability. When one of the multiple interleaved meshes according to this invention needs to change channels due to radar or other interference sources, the other mesh (or the others meshes if more than two parallel meshes are used) within the interleaved mesh architecture will continue to carry information during the “channel move time”. Here, when radar interference occurs on the channel of a first mesh of the multiple meshes of an interleaved mesh network, a second mesh can be used to propagate the command which causes other nodes to change channels as well as propagate normal traffic while the first mesh changes to a different channel. This eliminates the gap in performance that occurs when a DFS change is executed on prior art meshes. In order to implement DFS as just described, it is important that all nodes in the system are aware of the number of meshes available and the channels they each utilize.

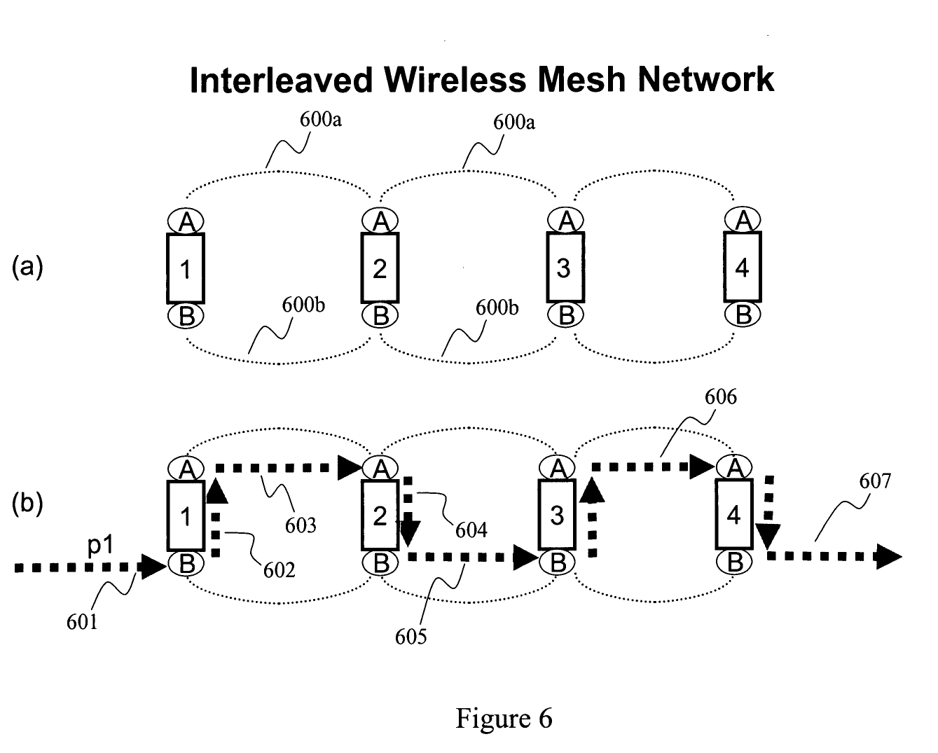

FIG. 6 shows a 1-dimensional architectural generalization for an interleaved wireless mesh according to this invention including a description for one scenario of packet propagation on an interleaved mesh. FIG. 6(a) shows four nodes, each supporting a wireless mesh 600(a) on channel A and another wireless mesh 600(b) on channel B. Omnidirectional antennas are assumed here. This four node mesh is shown here in basically a 1-dimensional “string of pearls” topology for sake of simplicity and clarity. It will be understood by those skilled in the art that all mesh networks described in this application can operate in a 2-dimensional mesh topology.

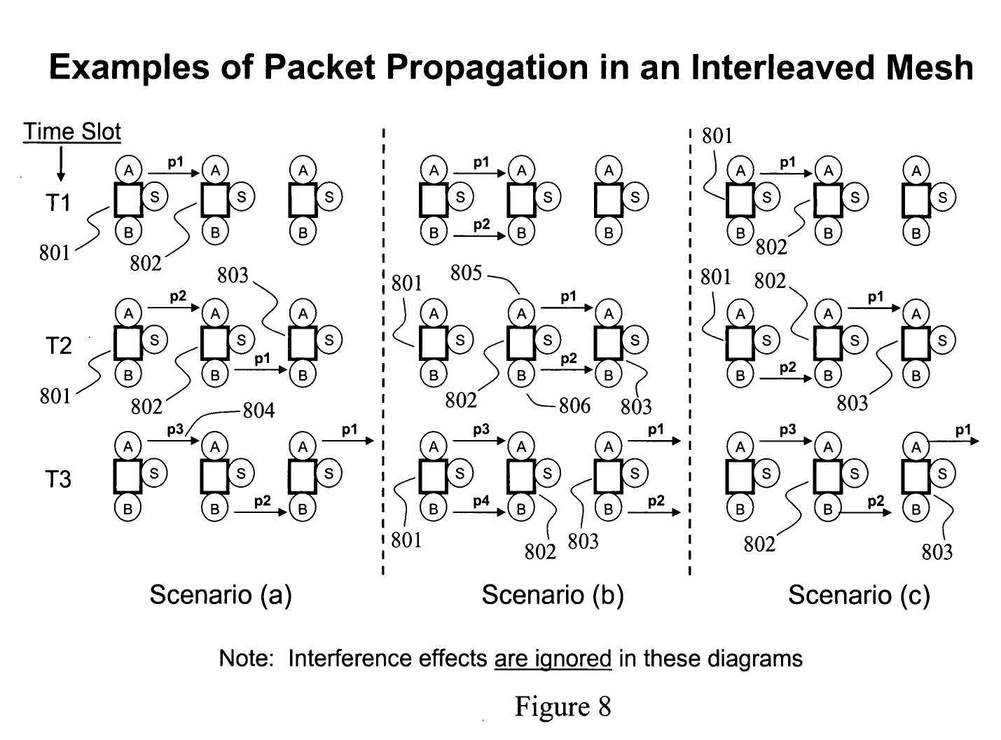

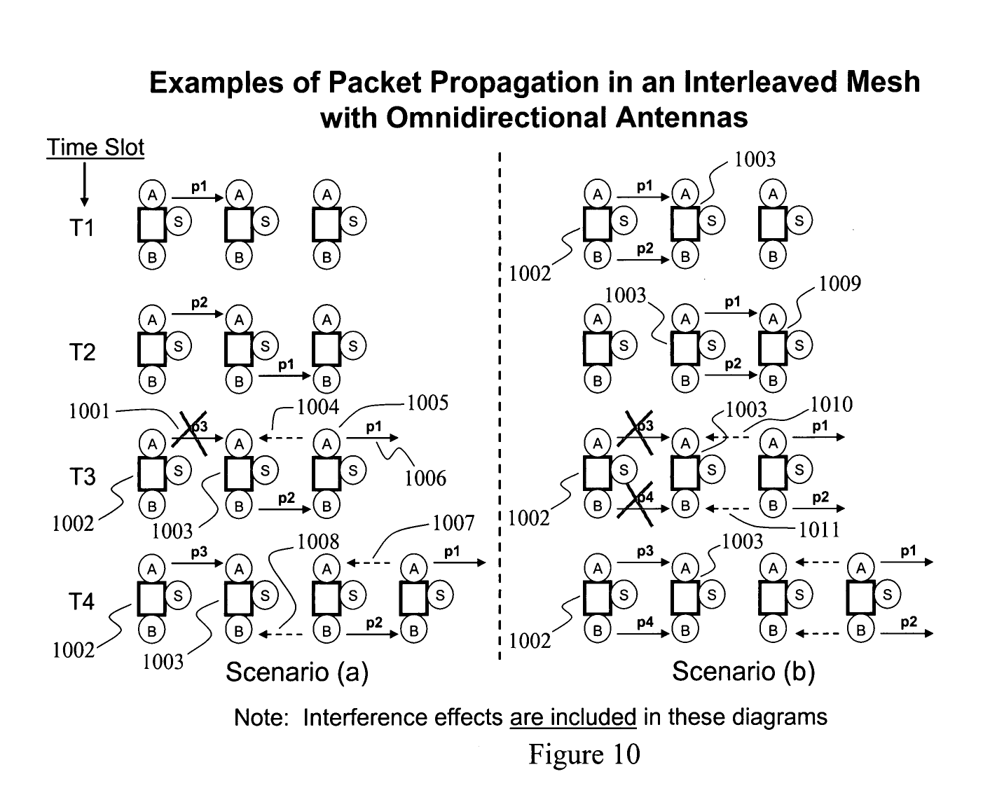

A possible packet propagation scheme for this interleaved mesh scenario is shown in FIG. 6(b) where a single packet p1 starts by entering 601 node 1 on the B-channel mesh. This same packet is then transferred 602 to the A-channel mesh from where it propagates 603 on the A-channel to node 2. The subject packet is then transferred 604 within node 2 back to the B-channel mesh, from where it propagates 605 to node 3. Thus, a single packet may bounce back and forth between one mesh and another mesh in a “ping-pong” or “interleaved” fashion as it propagates through the overall mesh network. At each of the four nodes shown, data can be received through either radio and if the other radio is currently free to transmit, then both radios on a node can be kept busy at the same time if interference effects allow (this will be discussed later). Other variations on packet propagation are possible and will be shown in more detail in FIGS. 8 and 10. Note that nodes with omnidirectional antennas (such as those shown in FIG. 6) can be utilized as mobile nodes, but it should also be apparent to those skilled in the art that such node configurations can be used in either fixed or mobile applications.

As a point of terminology, when a packet is transferred by RF transmission from one node to another, that transfer is referred to as a “hop”. Thus, in FIG. 6, transmissions 601, 603, 605, 606, and 607 all constitute hops, and per the definition of an interleaved mesh per this invention, a single packet may travel on any of multiple physical meshes (in this case the A-channel mesh or the B-channel mesh) for any given hop, as it travels through the overall mesh network.

In a multi-hop wireless mesh network, routing paths are typically planned in a distributed manner, each node determining where it must send a packet in order to move that packet towards an eventual destination. Thus, each node makes a decision for each packet that assigns that packet to a particular routing path. It is therefore very useful if each node has knowledge of other nodes in the network and any constraints that may exist at other points in the network. In other words, if there is a particular node in the network which is currently experiencing bandwidth limitations or an unusual amount of congestion, it is important for other nodes in the system to know this in order to direct packets in a direction that may bypass the impediment. At the same time, if connections between nodes exist in some other area of the mesh where bandwidth is especially high or congestion especially low, this information can also be useful in directing packets along the most optimum routing path. Again it is useful for a particular node to have knowledge of other nodes and connections within the mesh. Therefore in the interleaved mesh network according to the present invention, it is useful for each node to understand which other nodes in the network also have interleaved multi-radio relay capability, in order to plan the most optimum routing path.

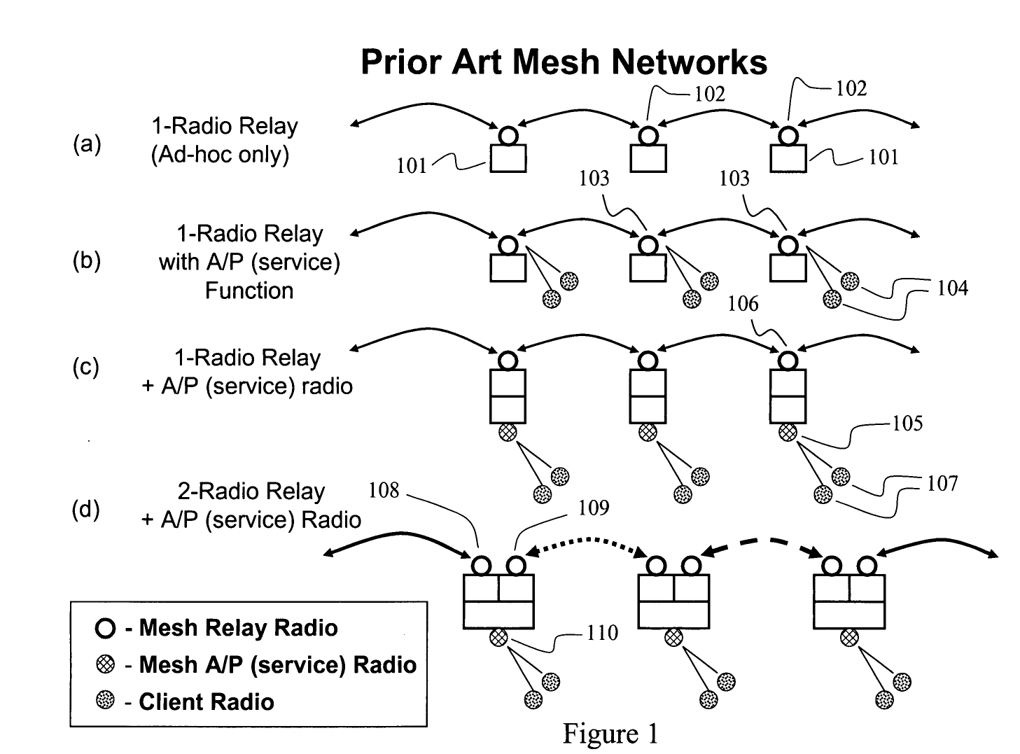

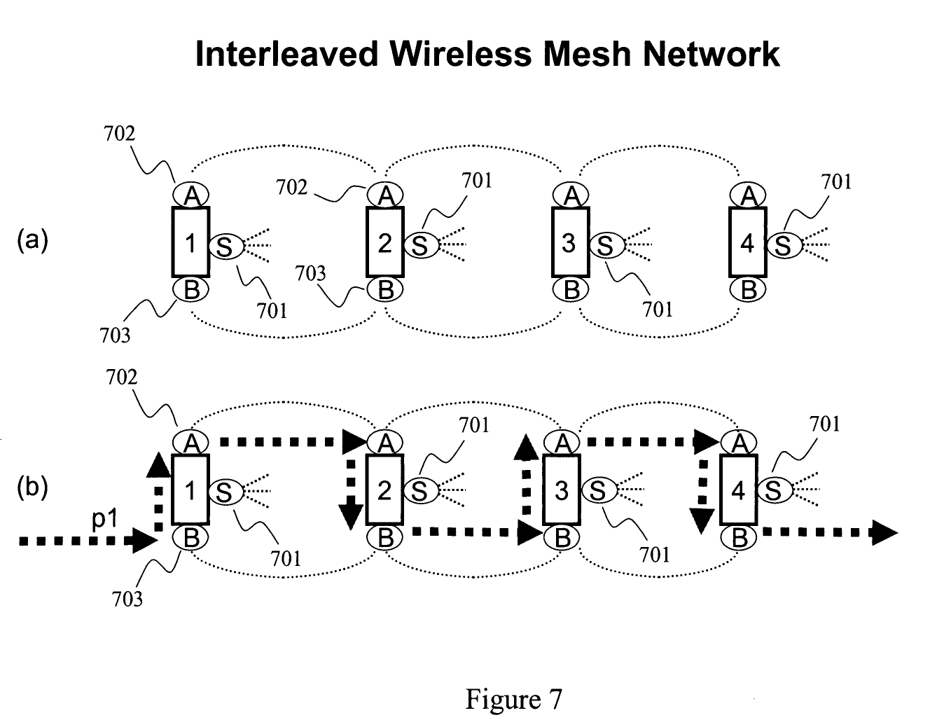

FIG. 7 is essentially identical to FIG. 6 but adds the functionality of a service or AP (access point) radio 701 which has been added to each mesh node. As embodied in a variety of prior art mesh architectures including FIGS. 1(c) and (d), having a separate service radio enables the relay radios 702 and 703 to operate on different channels (frequencies) than the service radio. Also, having a separate service radio provides for simultaneous operation of relay and service radios thus increasing overall performance.

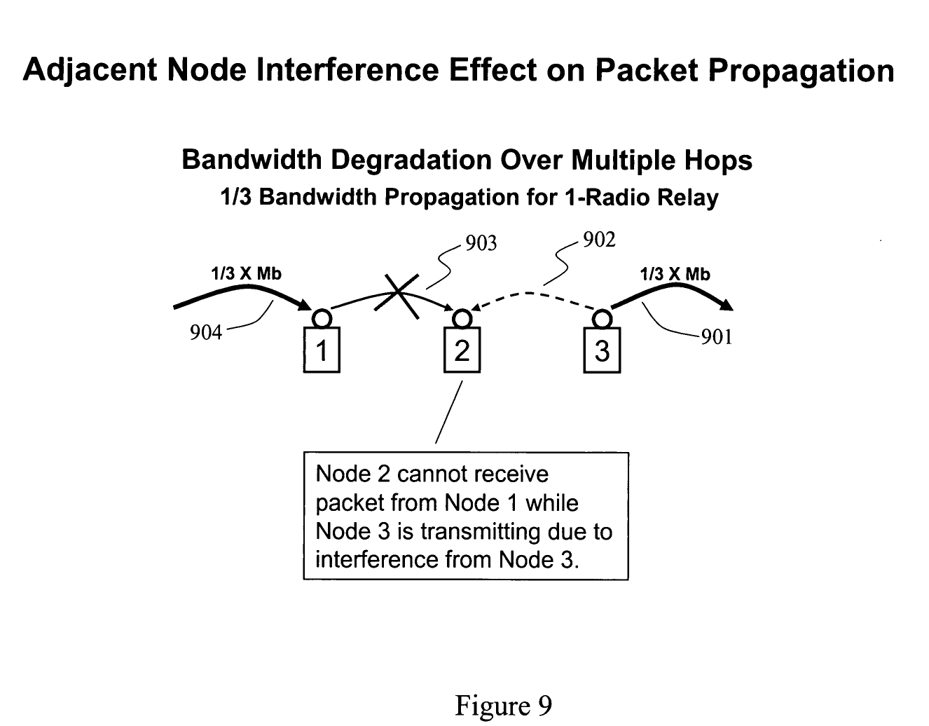

FIG. 8 shows examples of packet propagation scenarios through an interleaved or ping-pong mesh. Three scenarios are shown, (a), (b), and (c) for the propagation of sequential packets p1 through p4. For each scenario, packet propagation is shown for three sequential time slots, T1, T2, and T3. For the description of FIG. 8, adjacent node interference effects are temporary ignored to allow a simpler initial explanation of packet propagation. These effects will be explained in FIG. 9 and then incorporated into the packet propagation description in FIG. 10.

Timeslot T1 of scenario (a) in FIG. 8 shows packet p1 leaving node 801 and traveling to node 802 by way of the channel A mesh. Continuing scenario (a), timeslot T2 shows packet p1 progressing from node 802 to node 803, but this time propagating by way of the B-channel mesh. Concurrent with the propagation of packet p1 just described, packet p2 propagates from node 801 to node 802 on the A-channel mesh, thus demonstrating the ability of interleaved mesh nodes to simultaneously transmit and receive. Continuing scenario (a) further, timeslot T3 shows packet p1 and p2 progressing further, having “ping-ponged” to the opposite mesh, while packet p3 now enters the propagation stream 804 following p1 and p2 in sequence. Thus, it is also demonstrated that while packets in an interleaved or ping-pong mesh may travel on either of the multiple meshes for any given hop, the sequence of the packet stream is maintained such that the overall functionality is essentially the same as if only a single mesh had been used, except that performance has been increased due to simultaneity of transmission.

Scenario (b) of FIG. 8 demonstrates that sequential packets p1 and p2 may actually propagate simultaneously, each on a different mesh, even though in the packet stream, packet p1 precedes p2. Notice that in timeslot T2, packets p1 and p2 propagate simultaneously from node 802 to node 803, and that during this timeslot, no packets propagate from node 801 to node 802. This is due to the fact that the channel A and channel B radios 805 and 806 respectively cannot receive packets while they are transmitting packets. Subsequently in timeslot T3, packets p3 and p4 propagate simultaneously from node 801 to node 802, while packets p1 and p2 propagate simultaneously from node 803 onward.

Scenario (c) demonstrates that it is not required for a packet to utilize multiple meshes in the interleaved scheme. A packet can propagate solely on one mesh if the mesh control software in the various nodes decides that this is appropriate under the particular circumstances. This choice could relate to traffic patterns and also to interference effects. In timeslot T1 of scenario (c), packet p1 propagates from node 801 to node 802 via the A-channel mesh. In timeslot T2 of scenario (c), packet p1 further propagates from node 802 to node 803, also via the A-channel mesh. In timeslot T3 of scenario (c), packet p1 propagates beyond node 803 to another node in the mesh, also via the A-channel mesh.

As described above, it has been demonstrated that a sequential stream of packets can be propagated faster through an interleaved mesh architecture compared with architectures having a single radio relay structure. As dictated by the current traffic situation, two sequential packets may be propagated in sequence on one mesh of the multiple available interleaved meshes, or alternately these same two sequential packets may be propagated simultaneously on different meshes within the multiple available meshes. In certain embodiments, it is necessary that these sequential packets are delivered to their final destination in proper sequence and hence it may be necessary to provide a buffer memory on the receiving side such that when packets are transmitted in parallel and received out of sequence, the proper sequence can be restored. This restoration of the packet sequence is performed by the controlling software in the receiving node which upon examining the identification field in the IP header of each packet, determines the proper sequence of packets stored in the buffer. Thus, the multiple meshes within an interleaved mesh architecture according to this invention are able to propagate a stream of sequential packets at a rate at least double the rate of a prior art mesh with single radio relay capability.

In reality, if omnidirectional antennas are used, the scenarios of FIG. 8 would look somewhat different when interference effects of adjacent nodes are further taken into account. These effects are described in more detail in FIG. 9. Here node 3 is transmitting 901 a packet to a node elsewhere on the mesh network, and while it is transmitting in this desired direction, as a result of using an omnidirectional antenna, the packet is also being transmitted in the opposite (undesired) direction 902 back towards node 2. Thus, while it would be desirable for node 2 to receive a packet from node 1 while node 3 is transmitting, such a packet transfer 903 is not possible and thus is shown with a “X” through it. As a result, node 1 is not able to transmit to node 2 but is able to receive 904 from some other node in the mesh network simultaneously with the transmission 901 from node 3. The result of this interference effect is that when examining a pipelined propagation of packets through a mesh with a 1-radio relay, only every third timeslot will actually propagate a packet, resulting in an actual propagated bandwidth of ⅓ that which the radios themselves are able to transmit and receive. Since this is a pipelined effect, after 4 hops the effect remains stable and the bandwidth degradation consistent. Of course most mesh installations are 2-dimensional topologies, not 1-dimensional as shown here for clarity. A 2-dimensional mesh will have further interference effects regardless of the architecture chosen. In the interleaved mesh according to this invention, much of this adjacent node degradation effect just described is offset by using multiple interleaved meshes to increase the simultaneity of packet propagation. In other words, by sending a packet stream simultaneously over two or more parallel meshes, the present invention can increase the overall effective propagation rate of a packet stream from the one third rate just described to a rate equal to two thirds or better of that which the radios themselves are able to transmit and receive. Note that the effect just described in FIG. 9 is the result of omnidirectional antennas which transmit in all directions, not just the desired direction. One object of this invention is to provide a directional mesh solution that provides packet propagation consistent with an interleaved mesh as described, but minimizes or eliminates the interference affects of FIG. 9 by implementing the interleaved mesh using directional or sector antennas (and sometimes additional radios) for fixed mesh installations where mesh nodes are more or less permanently mounted at a fixed location.

For mobile mesh applications such as police, fire department, and other first responders, as well as military applications, directional antennas are sometimes impractical and omnidirectional antennas must be utilized in spite of the limitations. Thus, FIG. 10 further describes packet propagation through an interleaved mesh specifically when omnidirectional antennas are utilized and adjacent node interference effects are present.

For scenario (a) in FIG. 10, timeslots T1 and T2 show packet propagation similar to scenario (a) of FIG. 8. In timeslot T3, a packet is unable to be transmitted 1001 from node 1002 to node 1003 due to interference 1004 from A-channel radio 1005 attempting to transmit 1006 packet p1 onward through the mesh. Packet p3 is finally able to propagate from node 1002 to node 1003 during timeslot T4. Notice that interfering transmissions 1007 and 1008 during timeslot T4 further impede packet propagation.

Scenario (b) in FIG. 10 starts with packets P1 and P2 being transmitted simultaneously during timeslot T1 from node 1002 to node 1003 on meshes A and B respectively within the interleaved mesh. During timeslot T2, these packets propagate further from node 1003 to node 1009. During timeslot T3, it would be desirable for packets p3 and p4 to be transmitted from node will 1002 to node 1003, however this is prevented by interference radiations 1010 and 1011 resulting from the transmission of p1 and p2 as shown. Finally, in timeslot T4, packets p3 and p4 are able to propagate from node 1002 to node 1003. Note that in scenario (b) of FIG. 10, packets P1 and P2 are transmitted simultaneously even though they are adjacent sequential packets in a particular packet stream. Thus, this particular packet stream is able to propagate at twice the rate that it would in a system with a conventional single radio relay, thereby increasing effective propagation rate of a single packet stream to at least ⅔ of that which the radios themselves are able to transmit and receive, when two parallel meshes are used for an interleaved scenario. This performance level includes the interference effects described for FIGS. 9 and 10.

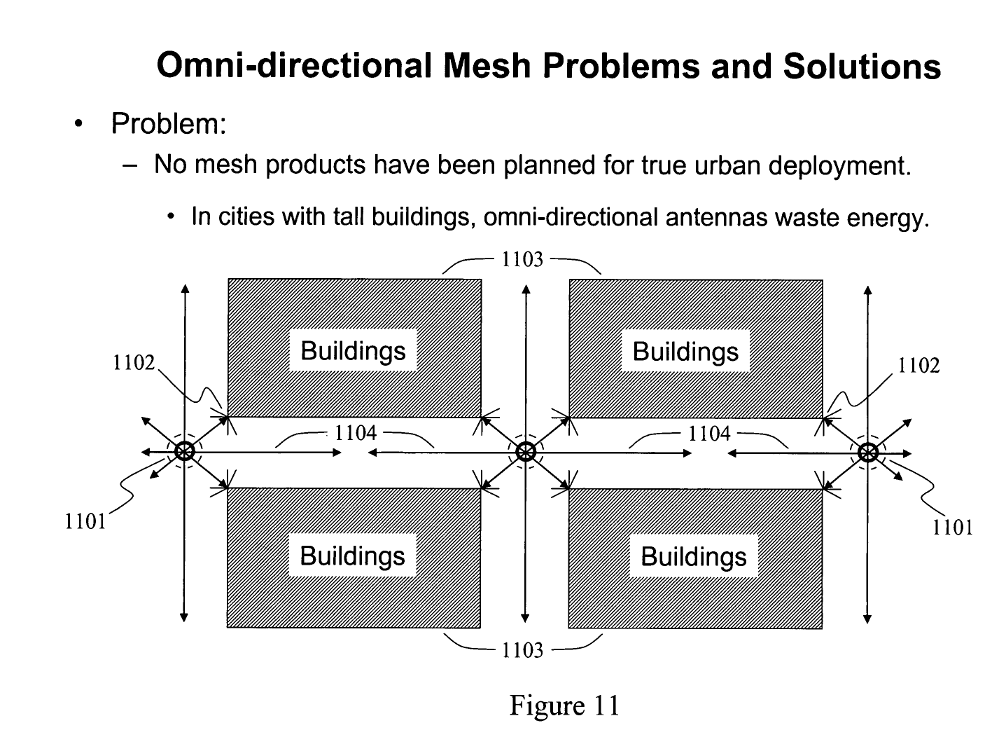

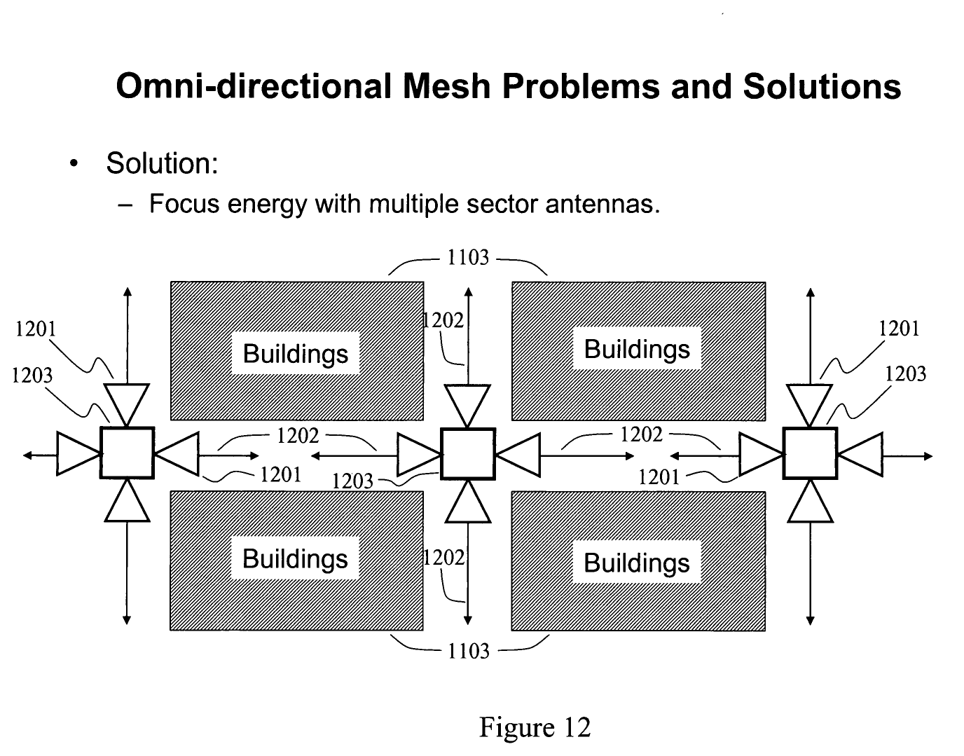

FIGS. 11 and 12 relate to deployment issues for mesh in urban applications. Today, most mesh nodes that are deployed utilize omnidirectional antennas. In urban applications, especially when tall buildings are present, omnidirectional antennas 1101 used for mesh relay radios waste most of their radiated energy as the wasted energy impinges 1102 on buildings 1103. Only a small portion 1104 of the radiated energy from a relay radio is actually directed toward an adjacent mesh node.

FIG. 12 demonstrates how directional or sector antennas can be utilized to focus a relatively narrow beam of radiated energy 1202 traveling between buildings 1103 to implement the communications link between relay radios 1201 on adjacent mesh nodes 1203.

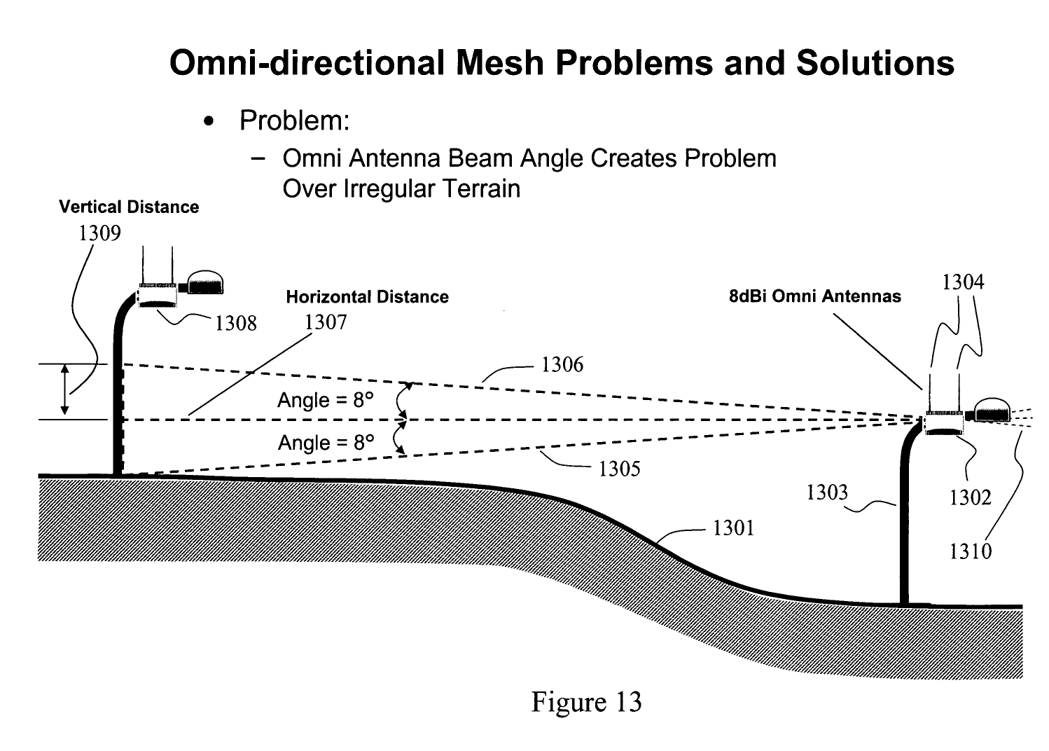

FIG. 13 demonstrates another problem that results when using omnidirectional antennas for relay radios on mesh nodes. Here, the mesh is deployed over terrain 1301 which is irregular in elevation. Mesh node 1302 mounted on a light pole 1303 has antennas 1304 which have been mounted to be vertical (the 2 antennas shown on each node in this figure are for diversity and are actually driven by a single radio). Assuming these antennas have a 16° vertical beam angle this means that the radiation pattern would fit within an envelope that extends between 8° below horizontal 1305 and 8° above horizontal 1306. Depending on the horizontal distance 1307 between mesh node 1302 and an adjacent mesh node 1308, the vertical distance 1309 defining the vertical envelope of the radiation pattern from node 1302 as viewed at the location of node 1308 may be too small to allow the radiation pattern to reach mesh node 1308. As a result, node 1302 and node 1308 may be unable to communicate. If antennas 1304 on node 1302 were instead tilted to allow the upper edge 1306 of the radiation pattern to reach note 1308, radiation patterns 1310 from node 1302 emanating in the opposite direction would be automatically tilted towards the ground, and as a result would be unable to connect to other mesh nodes in the opposite direction.

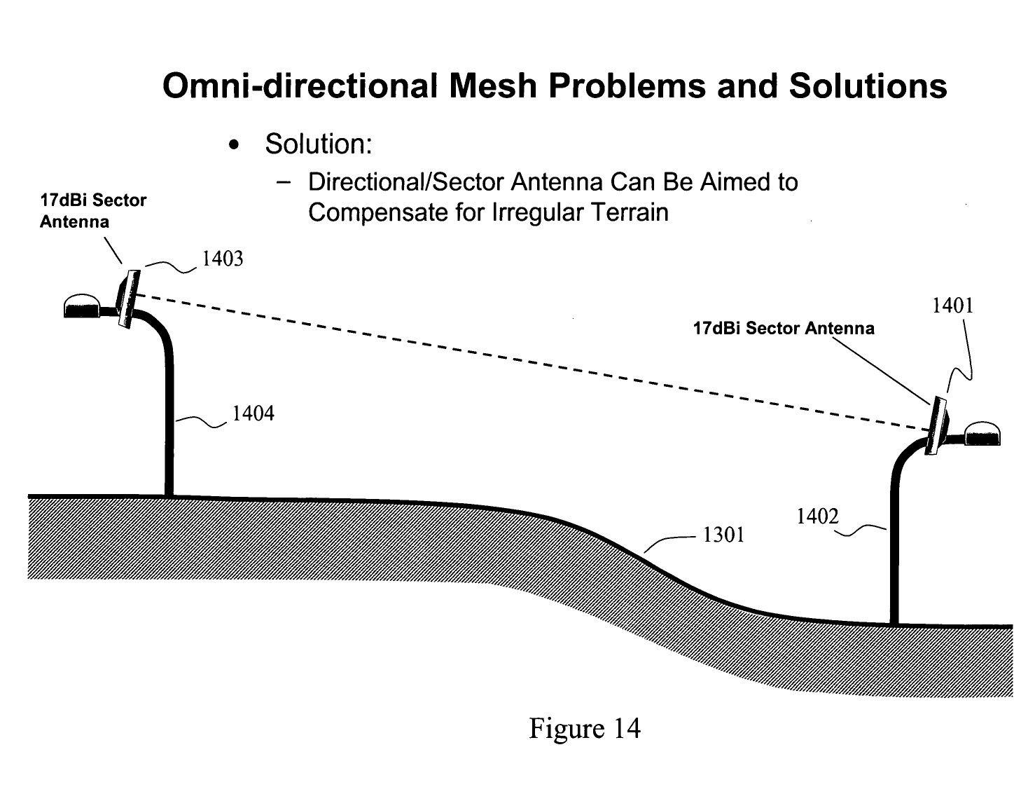

FIG. 14 shows how directional or sector antennas offer a solution to the problem of irregular terrain as demonstrated in FIG. 13. Here, sector antenna 1401 functions in conjunction with a relay radio connected to a mesh node on a light pole 1402. Antenna 1401 is adjustable for both azimuth and elevation enabling it to be vertically tilted to be aimed directly at antenna 1403 which is connected to a mesh node mounted on light pole 1404. Both antennas 1401 and 1403 are adjusted such that and they are aimed directly at each other thereby compensating for any variation in the elevation of terrain 1301. Note that additional sector antennas mounted on the same light poles can be aimed in other directions and adjusted differently for elevation in order to deal with further terrain irregularities.

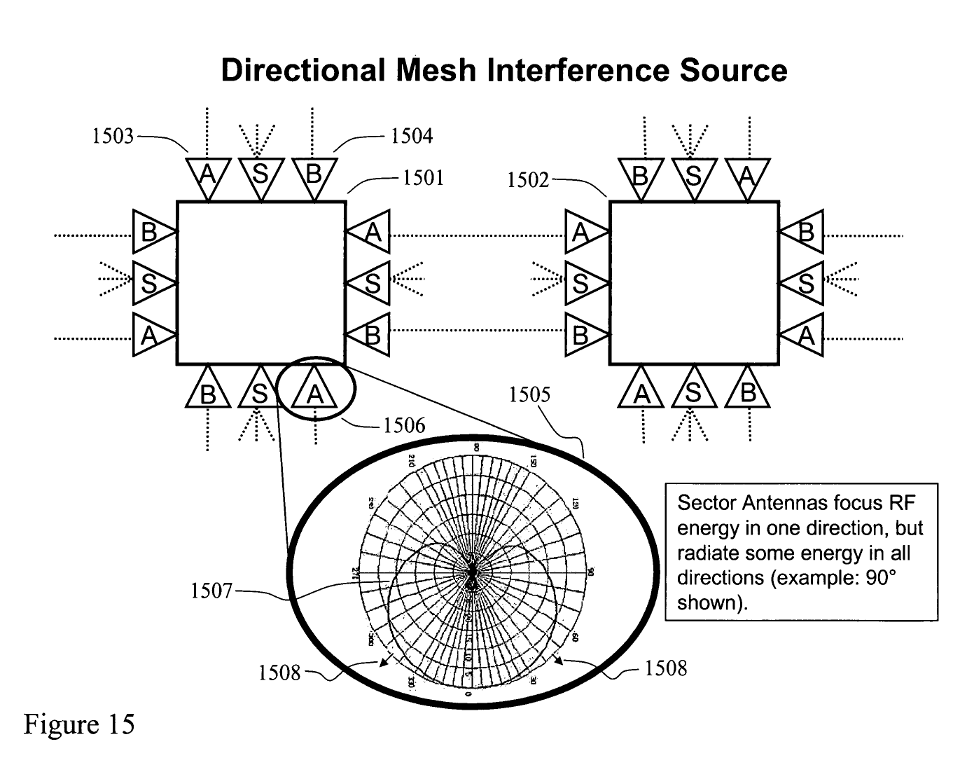

FIG. 15 shows two nodes 1501 and 1502 of a directional interleaved mesh according to this invention where multiple sector antennas are used in each of the four substantially orthogonal directions. (Note that where “orthogonal” is used in this specification to describe relative directionality, it means “substantially orthogonal” since there would typically be minor adjustments for azimuth and elevation of antennas to adjust for specific topological requirements.) Such nodes would be typically used in fixed locations within what would be typically called a fixed wireless mesh (as opposed to a mobile mesh). The channel assignments for the radios connected to each antenna are shown as letters within the antenna symbols such as A-channel antenna 1503 and B-channel antenna 1504. Notice that for each mesh node there is at least one antenna in each direction dedicated to channel A and another to channel B. This arrangement essentially replicates the interleaved mesh of FIG. 7 except that in each direction energy can now be focused more accurately. However if independent radios are connected to each of the antennas of mesh nodes 1501 and 1502, much higher performance is possible (due to simultaneity of transmit and receive) once solutions to the interference challenges have been implemented. A number of the figures that follow describe different strategies per the present invention for dealing with interference issues at a node, and provide varying degrees of increased performance. Regardless, note that in supporting both the A-channel mesh and the B-channel mesh of an interleaved mesh according to this invention, the fixed directional mesh nodes of FIG. 15 will communicate properly with mobile mesh nodes using omnidirectional antennas, should such mobile mesh nodes utilize the interleaved mesh architecture of FIGS. 5, 6, and 7.

Regarding the interference issues which arise once multiple antennas are placed in close proximity to one another and driven by radios operating on the same channel (co-channel operation), the enlargement 1505 of A-channel radio 1506 in FIG. 15 shows the horizontal radiation pattern 1507 typical of 90° sector antennas. Notice that the radiation pattern is reduced by 3 dB from its maximum at points 1508 which are 45° from the primary direction of the antenna. Also notice that even though most of the energy is focused in the primary direction, there is still considerable radiation throughout the remainder of the 180° span of the primary direction, and in fact some radiation is still present in a reverse direction. While this graph tends to indicate that little or no radiation is present directly opposite the primary direction, in fact most sector antennas have a specification called “front to back ratio” which is typically greater than 25 dB. However, even a signal that is 25 dB lower than the primary transmission may interfere with reception at other co-located antennas operating on the same channel depending on shielding and RF filtering characteristics. This explanation should therefore demonstrate why these co-channel interference issues should be addressed if fixed mesh nodes are to be constructed using multiple antennas with independent radios operating on the same channel.

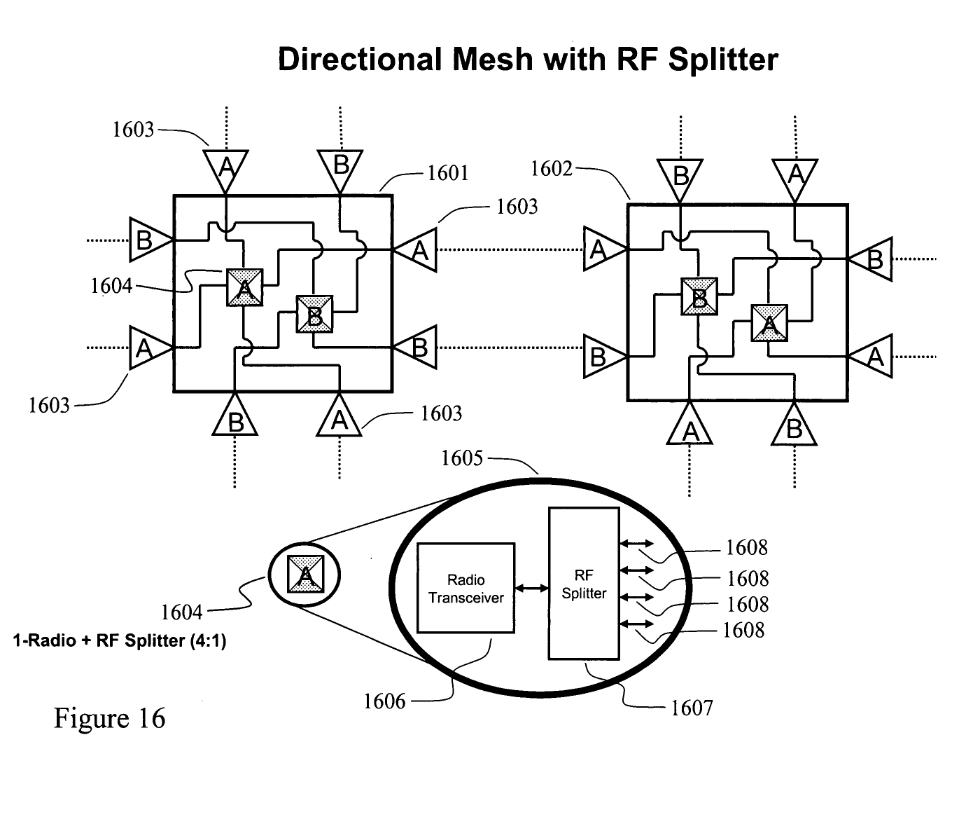

FIG. 16 shows a variation on the directional mesh of FIG. 15 and solves the co-channel interference problem by ensuring that all antennas on the same node and assigned the same channel are either transmitting or receiving simultaneously. Mesh nodes 1601 and 1602 are similar to nodes 1501 and 1502 but include provision for all A-channel antennas 1603 on a particular node to be driven by a single common radio. This is accomplished by combination radio/splitter 1604 which is shown in greater detail in enlargement 1605 where radio transceiver 1606 feeds RF splitter 1607 which divides the RF energy into four outputs 1608, each of these outputs going to one of antennas 1603. In this manner the four common channel antennas 1603 function in unison as if they were an omnidirectional antenna. Depending upon the horizontal beam width of each antenna, there can be gaps in the horizontal radiation pattern if each sector antenna has a beam width angle of less than 90°. However, if each antenna is a 90° sector antenna, the four antennas 1603 will exactly cover 360°. In the urban environment however we know that such a distribution will cause the majority the energy to impinge on buildings and be wasted. Thus, in a dense urban environment each of antennas 1603 could be chosen to have a more narrow beamwidth, for instance 45° or even 30° or less, thereby focusing transmit energy in the direction of other mesh nodes to which packets are to be relayed.

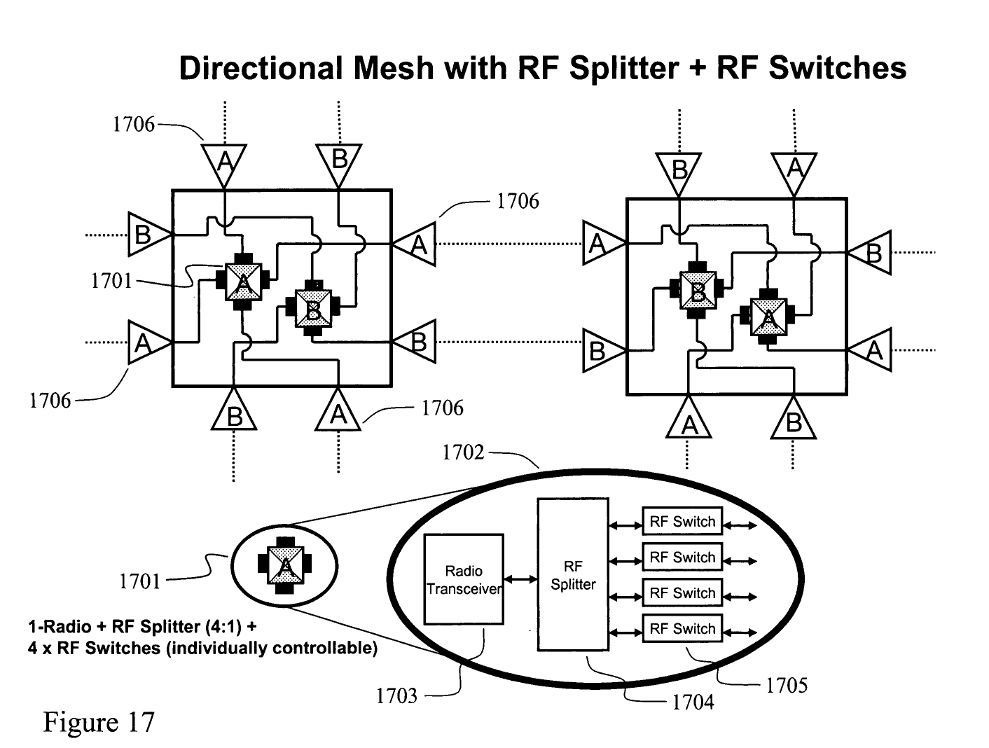

FIG. 17 shows a variation on the directional mesh node of FIG. 16 where individually controllable RF switches have been added as part of radio splitter combination 1701. Enlargement 1702 shows this combined functionality where radio transceiver 1703 feeds RF splitter 1704, the four outputs of which feed four individually controllable RF switches 1705 which in turn drive four common channel antennas 1706. The goal of this added functionality is to prevent the interference effect described in FIG. 9 from reducing performance of a mesh based on the node structure of FIG. 17. This is accomplished by controlling RF switches 1705 such that they only allow transmissions to pass when, in fact, it is desired to move packets in the specific direction associated with the particular antenna 1706. Thus, the adjacent node interference effect and degradation suffered by mesh architectures based on omnidirectional antennas and described in FIG. 9 will be avoided since the equivalent of transmission 902 in FIG. 9 will be blocked or prevented by a particular RF switch 1705.

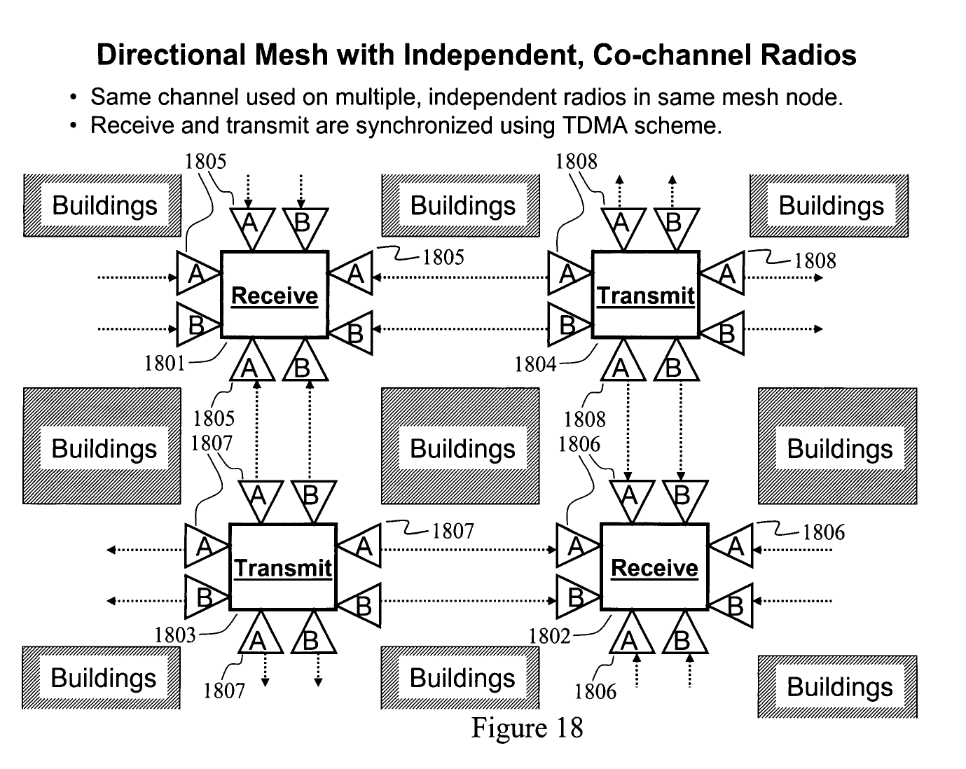

Still, the mesh node construction shown in FIG. 17 has the limitation of a single radio relay for each of mesh A and mesh B within the interleaved mesh architecture with regard to simultaneity of propagation. It is of course desirable to have multiple independent radios, each driving a directional or sector antenna such that a greater degree of simultaneity of transmitting and receiving can occur. The architecture shown in FIG. 18 utilizes independent radios driving each individual antenna (a radio-antenna combination) to achieve this additional simultaneity. In order to avoid the various interference affects described earlier in this application, each node in the mesh of FIG. 18 is controlled such that all co-channel radios in a particular node are synchronized to be receiving or transmitting in unison, or alternately such that no co-channel radios on a particular node are attempting to receive while one or more of them is transmitting. Thus A-channel radios 1805 and 1806 on mesh nodes 1801 and 1802 respectively would be receiving, while co-channel radios 1807 and 1808 on mesh nodes 1803 and 1804 respectively would be transmitting. Notice that this creates a pattern throughout a rectangular mesh grid where mesh nodes that are aligned diagonally through the grid operate in unison (relative to receive/transmit), and along any row or column the determination of which mesh nodes receive and transmit is defined by an alternating sequence. The coordinated scheme shown here could be part of an overall TDMA control scheme for the network. TDMA schemes (Time Division Multiple Access) are well known in the art.

Just observing for instance the operation of the A-channel radios of FIG. 18 per the previous paragraph, where mesh nodes that are aligned diagonally in the grid either transmit or receive in unison, it becomes evident that this method can increase the performance of a single channel mesh over conventional prior-art architectures without the addition of more radio-antenna combinations and the interleaved methodology. Of course, adding radio-antenna combinations and as well as the interleaved methodology with increase performance even further. Thus, a synchronized mesh can operate in this manner, with four independent relay radios each paired with a directional or sector antenna and operating on a common channel. Alternately, a single relay radio coupled to a splitter with independent RF switches connected between the splitter and separate sector or directional antennas can operate in a synchronized manner according to FIG. 18 while enhancing performance over prior art mesh architectures by further coordinating transmit/receive operations and thus eliminating the overhead losses normally associated with CSMA/CA governed communications.

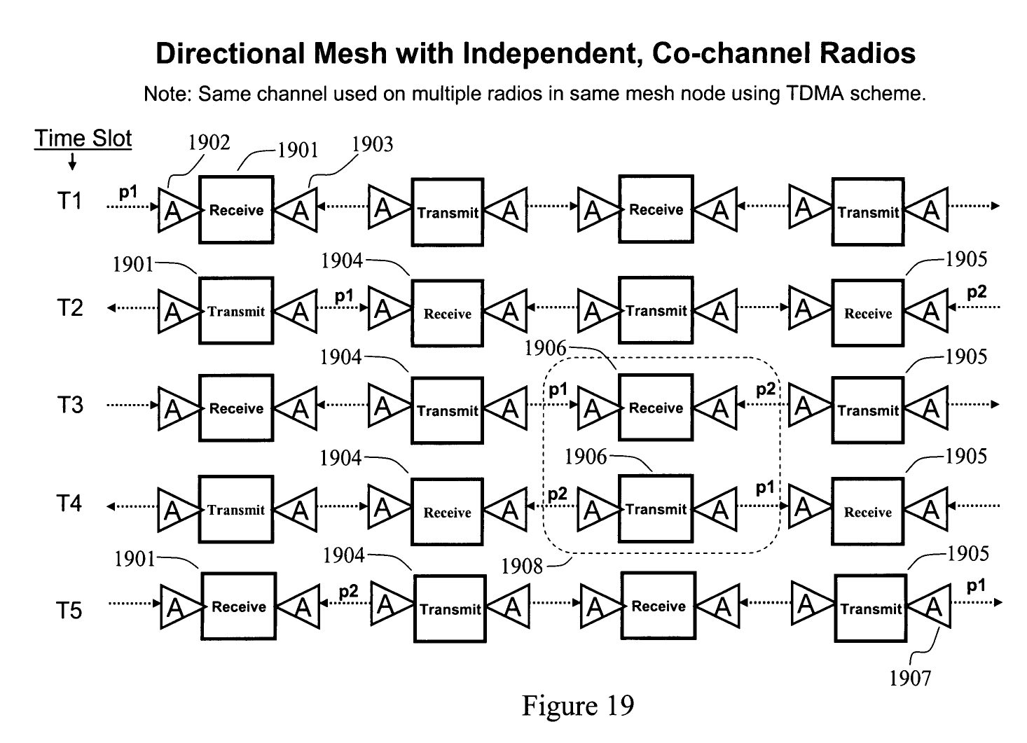

The operation of the mesh architecture described in FIG. 18 is shown in greater detail in FIG. 19 where the propagation of two packets, p 1 and p2, through the mesh in opposite directions is demonstrated. The sequence of packet propagation is shown in five sequential time periods, as defined by time slots T1 through T5. To simplify the operation of the mesh shown here for clarity, only the propagation through A-channel radios and antennas will be shown. In a full interleaved mesh as shown in FIG. 18, the performance would be further enhanced over the simplified explanation of FIG. 19.

Starting with time slot T1, packet p1 enters node 1901 through A-channel radio 1902, which according to the overall controlling scheme is in receive mode as is co-channel radio 1903 also on node 1901. During time slot T2, packet p1 is transmitted by node 1901 and received by node 1904 while simultaneously, packet p2 enters the mesh from the opposite side being received by node 1905. During timeslot T3, packet p1 is transmitted by node 1904 to node 1906 while simultaneously, packet p2 is also transferred from node 1905 to node 1906. Subsequently during timeslot T4, packet p1 is transmitted to node 1905 while packet p2 is transferred to node 1904. Finally, in time slot T5, packet p1 is transferred from node 1905 onward through the mesh by radio 1907 while packet p2 is transferred from node 1904 to node 1901. It is important to notice in FIG. 19 that each mesh node has demonstrated the ability to simultaneously receive from two directions at the same time or alternately transmit in two directions at the same time, which is easily seen by focusing on encircled nodes 1908. This simultaneity effectively increases the performance of the mesh to that of a full 2-radio relay capability.

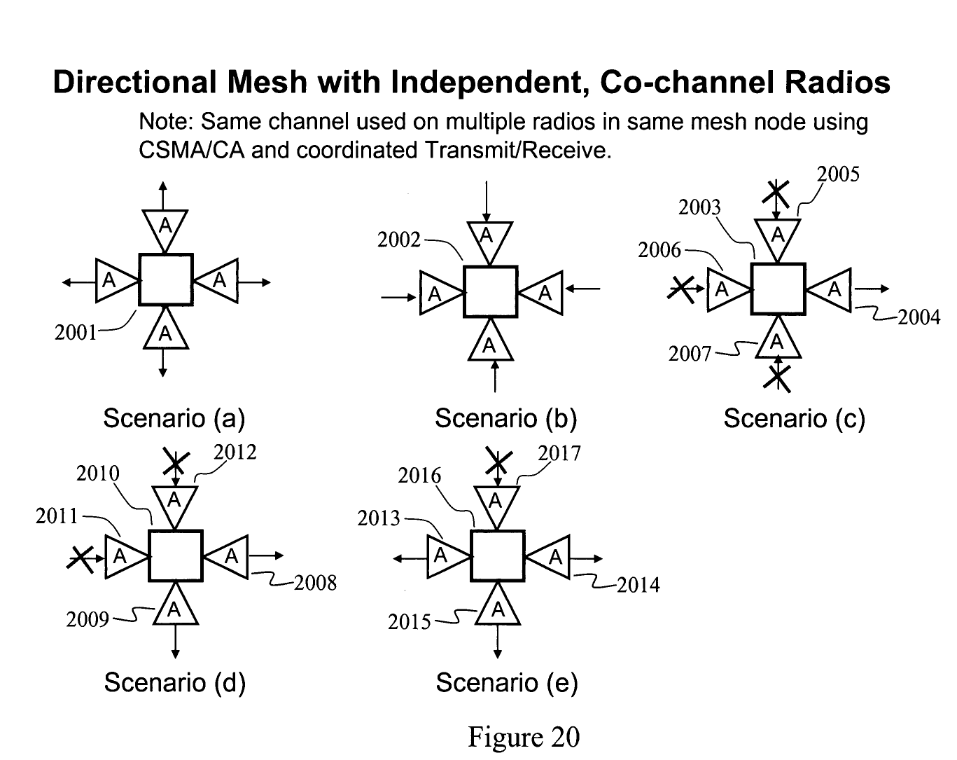

Without creating a full TDMA protocol scheme according to FIG. 19, it is possible to enhance a directional mesh with multiple independent co-channel radios on each node according to this invention, by controlling transmit and receive capabilities according to FIG. 20. As shown in scenario (a) of FIG. 20, mesh node 2001 has four independent co-channel radios each shown transmitting simultaneously in orthogonal directions, and since no co-channel radio on this node is attempting to receive, there is no co-channel interference problem. In scenario (b) of FIG. 19, all four independent co-channel radios on node 2002 are receiving simultaneously and again there is no co-channel interference problem. In scenario (c) of FIG. 20, A-channel radio 2004 on mesh node 2003 is transmitting while A-channel radios 2005, 2006, and 2007 are prevented by the controlling scheme from attempting to receive since such reception might experience co-channel interference. In scenario (d) of FIG. 20, co-channel radios 2008 and 2009 on node 2010 are transmitting while simultaneously, radios 2011 and 2012 are prevented from receiving. Last, in scenario (e) of FIG. 20, radios 2013, 2014, and 2015 on node 2016 are simultaneously transmitting while radio 2017 is prevented by the controlling scheme from receiving. Thus, according to FIG. 20, a grid of mesh nodes may be established in a manner similar to FIG. 19 with receive and transmit functions controlled so as to greatly reduce co-channel interference, while still utilizing a CSMA/CA protocol according to conventional 802.11 specifications. Notice that the method just described for controlling transmission and reception at a particular node to avoid co-channel interference can be applied to an array of mesh nodes which may or may not be organized in a regular grid fashion.

Besides using the synchronization method just described for reducing or eliminating co-channel interference within a particular mesh node, synchronization can also be used to eliminate adjacent channel or cross channel interference at a particular node by synchronizing radios. Cross channel interference refers here to interference between radios operating on different RF channel frequencies where these RF channel frequencies are separated by a space of at least one additional RF channel separating them, but still experience some degree of interference among them nonetheless. Looking specifically at an interleaved mesh node having two radios, depending on the frequency bands which are utilized, there may be a strong propensity for cross channel interference even with a separation of channels that would normally be considered more than adequate in some frequency bands. Such a situation can occur in lower frequency bands such as those between 700 and 900 MHz, which are known to cause interference when two radios are placed in close proximity even when separated by some number of RF channels. Therefore, a synchronized interleaved mesh node having two radios will have little or no cross channel interference between these radios if they are synchronized such that both radios are either transmitting or receiving simultaneously. Alternately the goal of avoiding cross channel interference can be stated as never allowing the situation where one radio is transmitting while the other radio is receiving. An efficient way to achieve this goal is to implement a synchronized TDMA type of scheme where all radios of concern on a particular node receive or transmit in unison as controlled by their assigned time slots in the TDMA scheme, or at least when one is transmitting, the other is not allowed to receive.

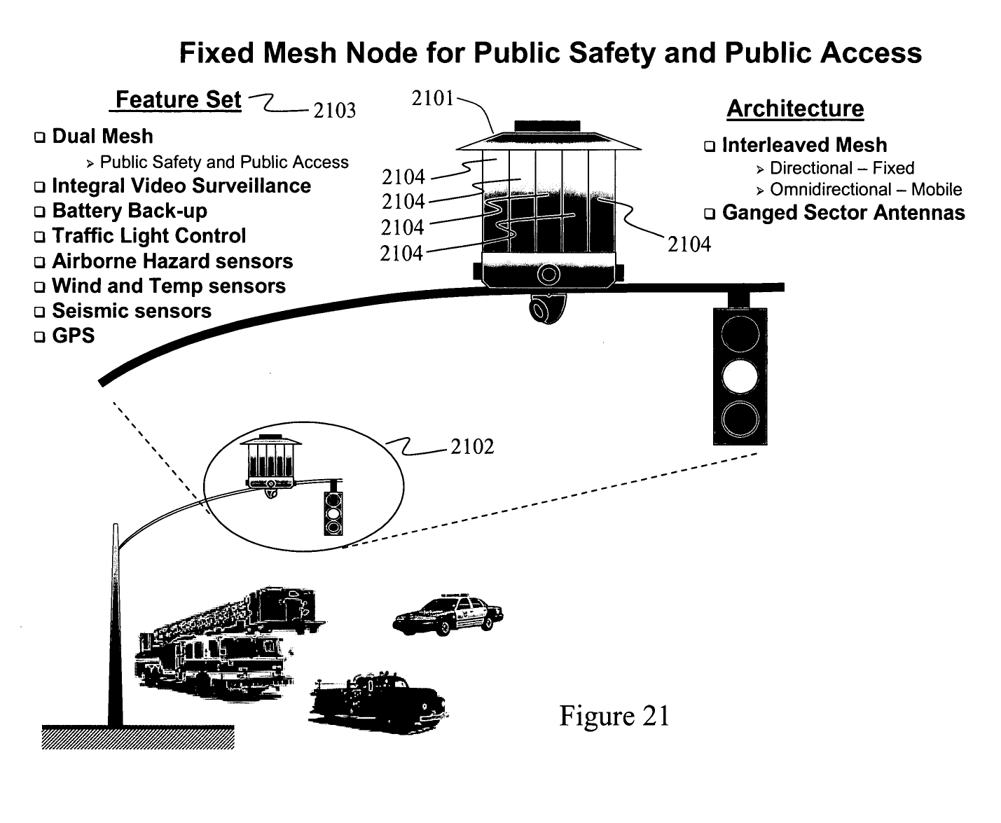

FIG. 21 shows what fixed directional interleaved mesh node might look like in an actual real world installation. Here, such a mesh node 2101 is shown mounted at traffic intersection 2102. In addition to supporting WiFi service for general public access applications, such a mesh node can support a variety of public service capabilities such as those listed in feature set 2103, including, either integral with or attached to node 2101, various sensors for video surveillance and airborne hazardous materials as well as seismic and wind sensors. The inclusion of these and other appropriate public safety-related sensors enables a grid of such mesh nodes to effectively form a comprehensive sensor network covering a metropolitan area. Supported by a battery backup system, such a node can also control traffic signals in the event of an emergency situation where today, such traffic signals would cease to function.

As shown in FIG. 21, four groups of five sector antennas are utilized. Each group of sector antennas 2104 can be implemented as a gang of antennas which have a fixed relationship to each other and can be adjusted for azimuth and elevation in unison.

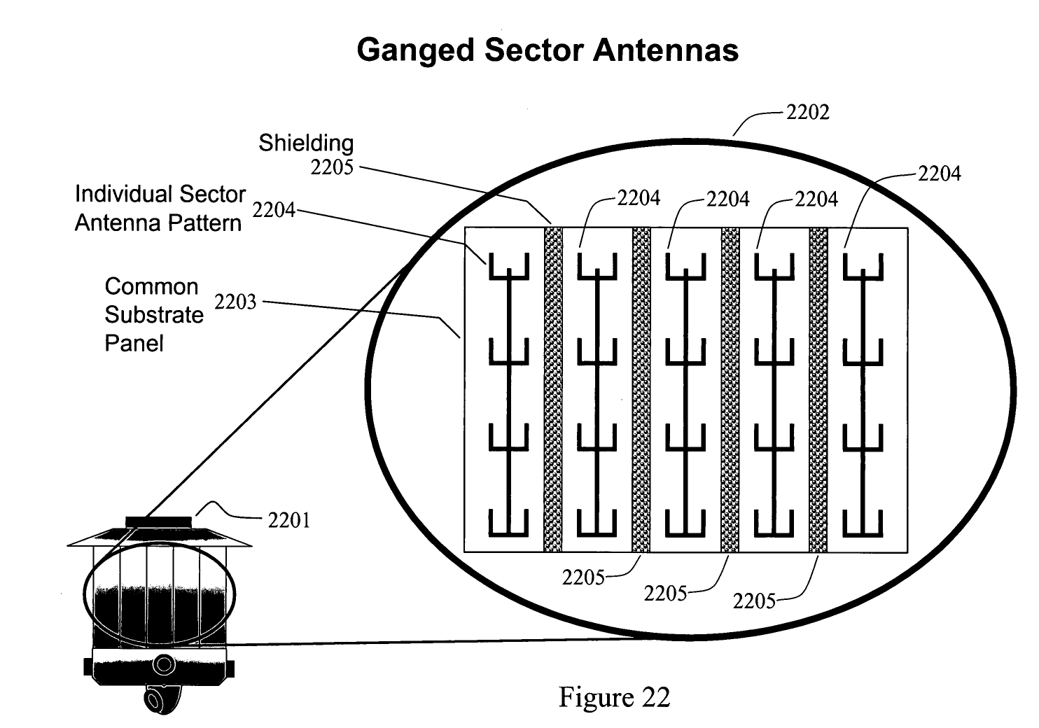

FIG. 22 shows fixed directional interleaved mesh node 2201 which is similar to mesh node 2101 of FIG. 21 and contains four ganged sector antennas, each antenna gang appearing as shown in enlargement 2202. Each antenna gang may be constructed on a common substrate panel 2203 which may consist of a standard printed circuit board (PCB) substrate material such as FR4 or other suitable material. Individual sector antenna conductor patterns can then be constructed simultaneously during the printed circuit board fabrication process to produce five individual antennas 2204 on one common PCB substrate 2203. Connections for shielding 2205 can be included in the conductor patterns created on PCB substrate 2203, and additional conductive material suitable for RF shielding can be mounted to PCB substrate 2203 at locations 2205 to provide additional shielding between individual antenna patterns 2204. In addition, other shielding measures can be provided within the overall enclosure of fixed mesh unit 2201 to further isolate each ganged sector antenna panel from the others in the enclosure. Note that to support MIMO (Multiple Input Multiple Output) radio-antenna combinations, the ganged antenna structure of FIG. 22 could be modified to include multiple antenna element patterns in place of each of patterns 2204 in FIG. 22.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

What is claimed is:

1. A synchronized directional wireless mesh network, comprising:
a substantially rectangular grid of at least four directional mesh nodes, each node having at least four radio-antenna combinations assigned to communicate on a common channel, each combination including a relay radio connected to an individual directional antenna wherein at least one of said radio-antenna combinations of a node is aimed in a substantially orthogonal direction relative to at least one other radio-antenna combination of said node; and
wherein all radio-antenna combinations, which are on mesh nodes that are aligned diagonally in the rectangular grid and which are operating on the same common channel, are adapted to transmit in unison and to receive in unison.

2. The synchronized directional wireless mesh network of claim 1 wherein any two adjacent mesh nodes in the rectangular grid are adapted to transmit and receive in an alternating sequence.

3. The synchronized directional wireless mesh network of claim 1 wherein mesh nodes that are aligned diagonally on the rectangular grid are not capable of transmitting directly to each other.

4. The synchronized directional wireless mesh network of claim 1 wherein each mesh node in the rectangular grid is adapted to simultaneously receive two or more packets from multiple adjacent nodes via the common channel.

5. The synchronized directional wireless mesh network of claim 1 wherein each mesh node in the rectangular grid is adapted to simultaneously transmit two or more packets to multiple adjacent nodes via the common channel.

6. A synchronized directional interleaved wireless mesh network, comprising:
a substantially rectangular grid of at least four directional interleaved mesh nodes, each node having at least eight radio-antenna combinations, each combination including a relay radio connected to a directional antenna wherein at least two of said radio-antenna combinations are aimed in one substantially orthogonal direction relative to at least two other radio-antenna combinations; and
wherein a first radio-antenna combination aimed in said direction is assigned to communicate on a first common channel, and a second radio-antenna combination aimed in said direction is assigned to communicate on a second common channel, and
wherein all mesh nodes aligned diagonally in the rectangular grid are controlled such that all radio-antenna combinations on each diagonally aligned node that operate on one of said first or second common channels are adapted to transmit in unison and to receive in unison.

7. The synchronized directional interleaved wireless mesh network of claim 6 wherein a mesh node is adapted to receive an IP packet on said first common channel and to transmit the IP packet on said second common channel to an adjacent mesh node.

8. The synchronized directional interleaved wireless mesh network of claim 6 wherein any two adjacent mesh nodes are controlled such that radio-antenna combinations that are operating on one of said first or second common channels on each adjacent node transmit and receive in an alternating sequence.

9. The synchronized directional interleaved wireless mesh network of claim 6 wherein a mesh node is adapted to transmit a first packet to an adjacent mesh node via the first channel while simultaneously transmitting a second packet to said adjacent node via the second common channel wherein said first packet is adjacent to said second packet in a sequential stream of IP packets.

10. The synchronized directional interleaved wireless mesh network of claim 6 wherein each mesh node in the rectangular grid is adapted to simultaneously receive two or more packets from multiple adjacent nodes via the first common channel.

11. The synchronized directional interleaved wireless mesh network of claim 6 wherein each mesh node in the rectangular grid is adapted to simultaneously transmit two or more packets to multiple adjacent nodes via the first common channel.

12. A synchronized wireless mesh network, comprising:
a substantially rectangular grid of at least four mesh nodes, each node having at least one relay radio connected to at least one antenna, said relay radio adapted communicate with radios on all adjacent nodes by way of a common channel;
wherein the rectangular grid is controlled such that relay radios, which are located on mesh nodes aligned diagonally in the rectangular grid and which are adapted to communicate on the same common channel, are adapted to transmit in unison and to receive in unison.

13. The synchronized wireless mesh network of claim 12 wherein said antenna is an omnidirectional antenna.

14. The synchronized wireless mesh network of claim 12 wherein said relay radio is connected to four directional antennas by way of an RF splitter and wherein at least one directional antenna of a node is aimed in a substantially orthogonal direction to at least one other directional antenna of said node.

15. The synchronized wireless mesh network of claim 12 wherein each node further includes a second relay radio connected to a second antenna and adapted to communicate with the second radio of every adjacent node via a second common channel.

16. The synchronized wireless mesh network of claim 15 wherein a mesh node is adapted to transmit a first packet via the common channel while simultaneously transmitting a second packet via the second common channel, said first packet being adjacent to said second packet in a sequential stream of IP packets.

17. The synchronized wireless mesh network of claim 15 wherein a mesh node is adapted to transmit a first packet via the common channel while simultaneously receiving a second packet via the second common channel, said first packet being adjacent to said second packet in a sequential stream of IP packets.

18. The synchronized directional wireless mesh network of claim 12 wherein any two adjacent mesh nodes in the rectangular grid are adapted to transmit and receive in an alternating sequence.

19. The synchronized directional wireless mesh network of claim 12 wherein mesh nodes that are aligned diagonally on the rectangular grid are not capable of transmitting directly to each other.

20. A directional wireless mesh network, comprising:
a plurality of directional mesh nodes, each node including at least four radio-antenna combinations assigned to communicate via a common channel, each combination including a relay radio connected to a directional antenna wherein at least one radio-antenna combination of a node is aimed in a substantially orthogonal direction relative to at least one other radio-antenna combination of said node; and
wherein all radio-antenna combinations of said node that are assigned to said common channel are controlled such that for time periods where at least one radio-antenna combination assigned to said common channel on said node is transmitting, non-transmitting radio-antenna combinations on said node that are assigned to said common channel are not allowed to receive.

21. The directional wireless mesh network of claim 20 wherein the plurality of directional mesh nodes include at least four nodes arranged in a substantially rectangular grid formation.

22. A directional wireless mesh network, comprising:
a plurality of directional wireless mesh nodes, each node including at least eight radio-antenna combinations, each combination including a relay radio connected to a directional antenna wherein at least two of said radio-antenna combinations are aimed in one substantially orthogonal direction relative to at least two other radio-antenna combinations;
wherein a first radio-antenna combination aimed in said direction is assigned to communicate on a first common channel, and a second radio-antenna combination aimed in said direction is assigned to communicate on a second common channel; and
wherein all radio-antenna combinations of a node that are assigned to one of the first common channel and the second common channel are controlled such that for time periods where at least one radio-antenna combination assigned to said one of the first common channel and the second common channel on said node is transmitting, non-transmitting radio-antenna combinations on said node that are assigned to the same common channel as the transmitting radio-antenna combination are not allowed to receive.

23. The directional wireless mesh network of claim 22 wherein the plurality of directional mesh nodes include at least four nodes arranged in a substantially rectangular grid formation.

24. A synchronized interleaved wireless mesh network, comprising:
a plurality of synchronized interleaved mesh nodes, each node having a first relay radio and a second relay radio, each relay radio connected to at least one antenna;
wherein the first relay radio on each node connects to the first relay radio of every adjacent node via a first RF channel, and the second relay radio on each node connects to the second relay radio of every adjacent node via a second RF channel; and
wherein said first relay radio and said second relay radio on each node are controlled such that for time periods where one of said first relay radio and said second relay radio on a particular node is transmitting, the other one of said first relay radio and said second relay radio on the particular node is not allowed to receive.

25. The synchronized wireless mesh network of claim 24 wherein said first relay radio and said second relay radio on each node provide alternative paths for receiving packets to each node and transmitting packets from each node such that an individual packet in a sequential stream of IP packets can utilize a different radio than a packet which precedes said individual packet in the sequential stream.
